(19) United States
(12) Patent Application Publication
(10) Pub. No.: US 2024/0067031 A1
(43) Pub. Date: Feb. 29, 2024

(54) METHODS AND SYSTEMS FOR SUSTAINABLE CHARGING OF AN ELECTRIC VEHICLE

(71) Applicant: Ford Global Technologies, LLC, Dearborn, MI (US)

(72) Inventors: Dominique Meroux, San Francisco, CA (US); Rani Murali, Dallas, TX (US); Hannah Bailey, Los Gatos, CA (US); Sunil Goyal, Canton, MI (US); Cassandra Telenko, San Francisco, CA (US); Dave Hurst, Berkley, MI (US)

(21) Appl. No.: 17/822,402

(22) Filed: Aug. 25, 2022

(51) Int. Cl. B60L 53/66; B60L 53/30; G06N 20/00

(52) U.S. Cl. CPC B60L 53/66; B60L 53/305; G06N 20/00; B60L 2240/70; B60L 2260/50

(57) ABSTRACT

Methods and systems are provided for transmitting a charging recommendation from a cloud-based server to an electric vehicle (EV), where the charging recommendation includes preferred options for charging stations and/or charging times. In one example, a method comprises receiving, at a cloud-based charging recommendation system of an EV charging system, a set of battery charging parameters from the EV via a secure anonymous connection; determining a set of candidate charging stations for the EV, based on the received battery charging parameters; estimating sustainability, cost, and preference metrics for each candidate charging station; ranking the future charge events based on the sustainability, cost, and preference metrics; selecting one or more charge options for the EV from the ranked future charge events; generating the charging recommendation with the one or more charge options; and transmitting the charging recommendation to the EV via the secure anonymous connection.

### FIELD

The present description relates generally to methods and systems for reducing lifecycle environmental impacts of an electric vehicle via charging strategies.

### BACKGROUND/SUMMARY

A plug-in electric vehicle (EV) operates on electricity stored in one or more batteries of the EV. When the stored electricity decreases below a threshold, the one or more batteries may be recharged at a charging station. The charging station may be coupled to a power grid, which may supply the electricity used to recharge the one or more batteries. Some public and private charging stations may additionally or alternatively use off-grid power (e.g., batteries and solar set-ups).

The electricity supplied via the power grid may be generated at one or more energy sources. The energy sources may be non-renewable energy sources, such as plants that burn fossil fuels including oil, gas, and/or coal. The energy sources may also be renewable energy sources, such as solar thermal electric plants, solar photovoltaic plants, wind farms, hydroelectric power plants, nuclear power plants, or a different renewable energy source. Each generation source will have a selection of associated environmental impacts, such as carbon emissions, emission of criteria pollutants, water consumption and land use impacts, etc. a set of lifecycle environmental impacts may be estimated for an EV charging event based on known information about candidate EV charging stations and associated generation sources of the electricity supplied to and consumed by the EV.

Regulators and users may weight lifecycle environmental impacts dependent upon on regional factors. In one example, a regulator may focus on CO2 targets making CO2 the key metric. In another example, where electricity production is in a same region as consumption, the region is facing a drought, and criteria pollutants are not a critical concern (for example, the region is not designated by US EPA as a non-attainment region), water consumption impacts of various power generation sources may be given greater weight over other criteria.

Environmental impacts of the electricity used to charge the EVs may vary across charging stations, due to different sources of energy and attributes of the charging infrastructure and operations. For example, the carbon footprint of the electricity used to charge the EVs may also vary with respect to a time of day or season of the year, based on factors including sunlight and wind intensity at renewable production facilities, and a power demand that may determine how many fossil fuel plants may be switched on to meet a demand for the electricity.

An EV owner, operator, or manufacturer may have a variety of incentives to reduce the environmental impact of the EV, based on existing and future regulatory credits, emissions trading schemes, and carbon taxes, as well as an interest in reducing environmental costs and global warming. However, the user may be unaware of varying environmental costs of charging the EV and may not have information regarding the most sustainable charging options given time and charging station attributes. For example, some EV networks or OEMs purchase renewable energy credits (RECs) to match electricity charged in certain geographic regions. 100% renewable energy (using RECs) is not however equivalent to net zero emissions. If energy produced by the renewable power source the REC is attributed to is generated at a low-carbon day or time of day and the EV charging takes place at a high carbon time of day, a net result might be low carbon mitigation. However, the inverse could also be true.

Renewable energy content is not the only metric that matters. For example, consider two charging stations: Station (A) Offers Level 2 charging, and features an off-grid solar panel and battery setup, dispensing 100% solar (renewable) energy. Station (B) is a DC Fast station where 100% energy is covered by renewable energy credits (RECs) and has on-site battery storage and grid-tie solar panels. A third option, Station (C), might be the same as Station (B) except for it includes large advertising screens at each charger. A fourth option, Station (D), might share attributes of Station (B), but in place of DC Fast, Station (D) may provide battery swapping and rely on storage and redistribution of batteries based on demand as well as a larger station footprint (size). Even further possibilities exist, like wireless charging, etc. Each of Station (A)-(D) has different on-site infrastructure components (manufacturing impacts), ongoing infrastructure servicing (maintenance), dispensing power output rates (vehicle and infrastructure battery degradation impacts and lifetime energy output), operational power usage (operations), efficiency losses, local land use impacts (station footprint), and distance deviation from the vehicle's intended route (additional energy and vehicle distance traveled to reach the charger). Stations (A)-(D) all offer 100% renewable energy; however, the true environmental impacts per kWh of choosing Station (A) vs. Station (B) would differ.

Various efforts have been made to increase the amount of information regarding maximizing renewable energy content of charging options available to users. Networking infrastructure has been developed to track usage of renewable energy sources at charging stations, as taught by US 2016/0072287, US 2011/0191186, and U.S. Pat. No. 9,024,571B2. Charging stations may be ranked based on an availability of renewable energy sources at the charging stations, as taught by US 2011/0191186 and US 2021/0201369 A1. Recommended charging strategies may also be outputted to EVs and/or users of the EVs (for example, based on charging station scores) that encourage drivers to charge the EVs at selected charging stations and/or times to reduce the carbon footprints of the EVs, as taught by U.S. Pat. No. 9,024,571 B2 and US 2021/0201369 A1. Positive reinforcement may be provided when a renewable energy charging source is available and has been utilized, as disclosed in US 2018/0118047 A1.

However, the inventors herein have recognized potential issues with respect to implementing such strategies to efficiently use the provided infrastructure to reduce the carbon and environmental footprint of the electricity used to charge an EV. While diverse solutions have been proposed with respect to infrastructure developments, ranking charging options based on energy sources, and providing charging recommendations to EV drivers, a systematic approach to managing the information transferred between EVs and a charging recommendation platform to generate useful recommendations is lacking. In the example, some implementations of renewable energy and infrastructure are preferable to others based on the previously mentioned regional and user factors such as accessibility, land use, water use, and other impacts. Charging strategy recommendations generated by current systems may not take into consideration a sufficiently broad diverse set of charging parameters, which may vary across different types of EVs. A communication of the charging parameters between the EVs and the charging recommendation platform may not sufficiently protect a privacy of the EVs and/or drivers of the EVs. The recommendations may not take into account different types of incentives provided to different EV operators, or differing priorities of drivers and incentives. A quantifiable effect of the recommendations with respect to an amount of a reduction in the EV's carbon footprint may not be provided, for example, in reference to a baseline, industry average, or alternative scenarios, and a carbon footprint reduction over time based on following the recommendations may not be tracked. As a result, sufficient information may not be generated to support the creation of additional or future incentives, such as proposed environmental impact (such as carbon) offset opportunities local to a decision-maker (e.g., an owner, a driver, a fleet manager, etc.), that might lead to a faster overall transition to net zero environmental impacts of transportation.

As an example, a first driver of a first EV may wish to recharge the first EV based on a first set of priorities. The first driver may have an ethical desire to reduce the first EV's carbon footprint, but may be sensitive to a price of electricity. The first driver may wish to recharge the first EV quickly, and may prefer stations with faster chargers. The first EV may have a small battery, and the first driver may recharge the first EV infrequently. A second driver of a second EV may wish to recharge the second EV based on a second, different set of priorities. The second driver may operate a delivery vehicle for a company, and may charge the second EV based on a combination of personal and corporate priorities. The company may purchase RECs and may provide incentives for its drivers to reduce the carbon footprint of the second EV. The second EV may have a large battery that may be recharged infrequently, and the second driver may charge the second EV during the second driver's free time, whereby a recharging time is not a priority to the second driver. Thus, a first set of charging parameters used to generate a recommendation for where to charge the first EV may be different from a second set of parameters used to generate a recommendation for where to charge the second EV. While current charging recommendation systems may provide a generic recommendation based on a relative percentage of renewable energy sources used to generate electricity, the generic recommendation may not take into consideration the different priorities reflected in the different charging parameters. As a result, the generic recommendation may not be a most desirable option for either the first driver or the second driver.

Additionally, a transmission of vehicle and/or driver data between the first and/or second EV and the charging recommendation systems may not be secure. For example, vehicle location and route information retrieved from an onboard navigation system used to identify nearby charging stations may be intercepted by or sold to marketing companies, which may target the first and/or second driver with undesired advertisements (e.g., on a phone or dashboard display) for businesses located along a travelled route. As a result of a driver experience of the charging recommendations being poor, a usage of the charging recommendation systems by the first driver and/or second driver may decrease over time. Further, such recommendations might not be trusted by customers or by regulators - especially if there is suspicion that third party commercial marketing interests take priority over truly recommending sustainable charging strategies.

In one example, the issues described above could be at least partially addressed by a system for an electric vehicle, the system comprising a controller storing executable instructions in non-transitory memory that, when executed, cause the controller to, prior to a future charge event of the EV, establish a secure anonymous connection with a charging recommendation system external to the EV; select a plurality of battery charging parameters to transmit to the charging recommendation system based on a classification and/or ranking of a relevancy of the battery charging parameters; transmit the selected battery charging parameters to the charging recommendation system via the secure anonymous connection; receive a charging recommendation for the future charge event of the EV from the charging recommendation system via the secure anonymous connection, the charging recommendation based at least partly on the selected battery charging parameters; and display the charging recommendation in a display of the EV and/or store the charging recommendation in a memory of the EV. By selecting a set of battery charging parameters relevant to the priorities of a specific driver or EV, a customized recommendation may be generated that accurately reflects the priorities.

The customized recommendation may lead to a wider adoption of the charging recommendation system, resulting in reductions in environmental impacts of EVs and providing estimates of that reduction to be used for reporting impact reductions such as for investor reporting or claiming of regulatory credits. Charging station operators may be encouraged to improve sustainability of their charging locations to remain competitive. To quantify impacts of such recommendations on a macro level, for example for regulatory credits, numerous potential mechanisms exist. One approach may be to provide scenario analysis and rank actual performance among scenarios, while another option would be difference in difference regression. Because even choosing the most sustainable charging strategies will typically have non-zero environmental impacts, these impacts may be identified and used to propose offset opportunities to achieve net zero. Further, by transmitting the relevant battery charging parameters via the secure anonymous connection, a privacy of the driver and data associated with the EV may be protected.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows an electric vehicle charging system, in accordance with one or more embodiments of the present disclosure;

FIG. 2 shows a schematic diagram including components of an electric vehicle and a charging recommendation system of the electric vehicle charging system of FIG. 1, in accordance with one or more embodiments of the present disclosure;

FIG. 3A is a flowchart illustrating a high-level method for implementing a charging recommendation system for electric vehicles, in accordance with one or more embodiments of the present disclosure;

FIG. 3B is a flowchart illustrating an exemplary method for assessing sustainability within a charging infrastructure, in accordance with one or more embodiments of the present disclosure;

FIG. 3C is a flowchart illustrating an exemplary method for measuring a baseline of environmental costs of EV charging habits, in accordance with one or more embodiments of the present disclosure;

FIG. 3D is a flowchart illustrating an exemplary method for identifying and encouraging drivers to use more sustainable EV charging options, in accordance with one or more embodiments of the present disclosure;

FIG. 3E is a flowchart illustrating an exemplary method for identifying and encouraging charging stations to supply more sustainable EV charging, in accordance with one or more embodiments of the present disclosure;

FIG. 3F is a flowchart illustrating an exemplary method for measuring an effect of interventions into driver behavior via charging recommendations, in accordance with one or more embodiments of the present disclosure;

FIG. 4A is a flowchart illustrating an exemplary method for requesting and receiving a charging recommendation at an EV from a charging recommendation system, in accordance with one or more embodiments of the present disclosure;

FIG. 4B is a flowchart illustrating an exemplary method for generating a charging recommendation at a charging recommendation system for an EV, in accordance with one or more embodiments of the present disclosure;

FIG. 5 is a graph showing a level of carbon generation due to generation of electricity at various times of the day;

FIG. 6 is a bar chart showing an exemplary charging strategy of an electric vehicle, in accordance with one or more embodiments of the present disclosure; and

FIG. 7 is a flowchart illustrating an exemplary method for assigning an environmental cost value to a charge event, based on a grid mix of different energy sources used to charge an EV, in accordance with one or more embodiments of the present disclosure.

### DETAILED DESCRIPTION

Systems and methods are provided for transmitting a charging recommendation from a cloud-based server to an electric vehicle (EV), where the charging recommendation includes preferred options for charging stations and/or charging times. The preferred options may reflect a charging strategy designed to reduce environmental impacts of the EV, by directing a driver of the EV to charging options that minimize per kWh environmental impacts of one or more impact categories, or of an index created by weighting various categories, where environmental impacts per kWh are calculated using best available information on charging infrastructure attributes as described in the Background/Summary. As described herein, the charging recommendation may be based on a plurality of battery charging parameters that are sent from the EV to the cloud-based server via a secure anonymous connection. The battery charging parameters may be selected and/or ranked by a controller of the EV prior to being transmitted to the cloud-based server, and the selection and/or ranking may capture priorities of the driver or an owner of the vehicle. The cloud-based server may use the battery charging parameters to generate the charging recommendation based on the captured priorities. The charging recommendation may be based at least partly on an environmental cost value assigned to a potential charge event, the calculation of which is described herein. By following the charging recommendation, the driver may rely on a greater amount of renewable energy when recharging the EV, thereby lowering the carbon footprint of the EV. By generating the charging recommendation in the manner disclosed herein, via a customized set of battery charging parameters, the charging recommendation may be customized to meet the priorities of the driver and/or the EV to a greater degree than other charging recommendation systems, which may issue generic charging recommendations based on less data.

Note that although the discussion herein is described with respect to electric vehicles, the embodiments described herein are applicable to any form of plug-in vehicle, such as battery powered vehicles or hybrid vehicles, that are recharged by plugging into an electric grid.

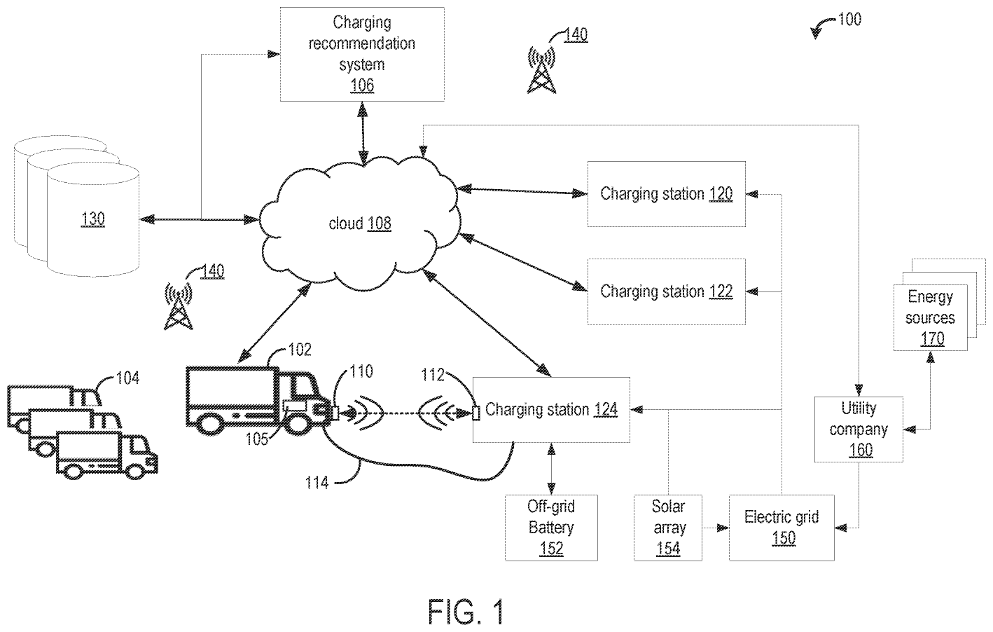

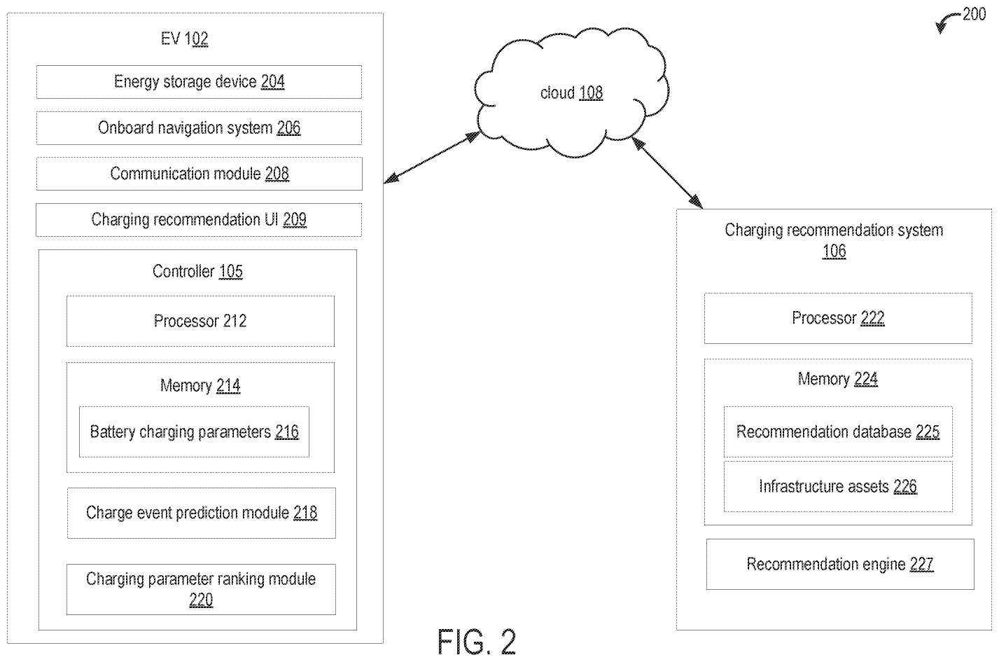

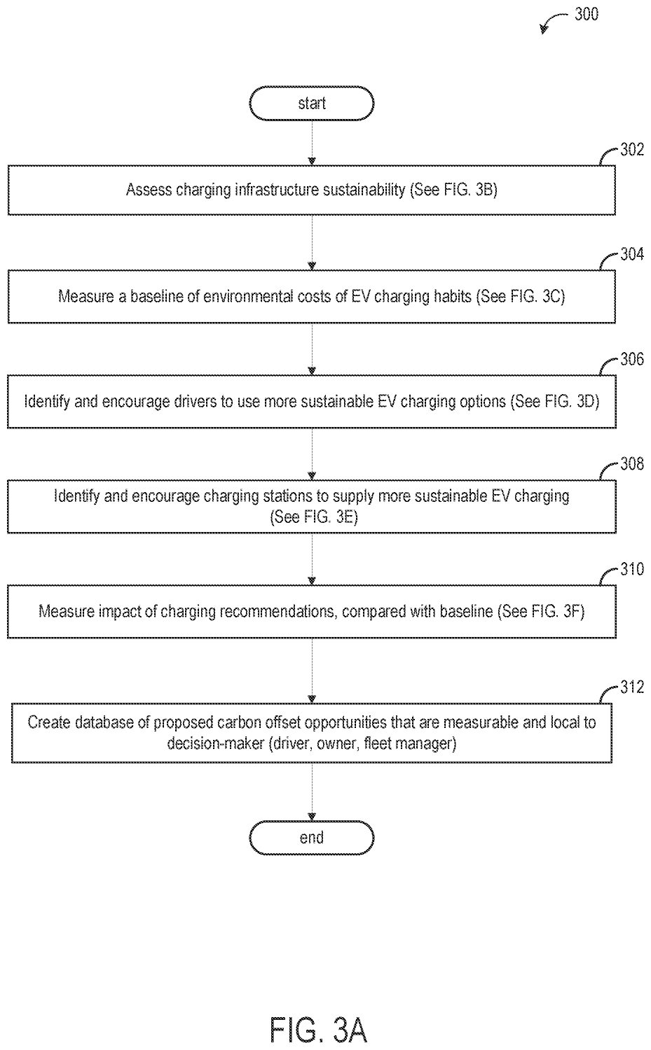

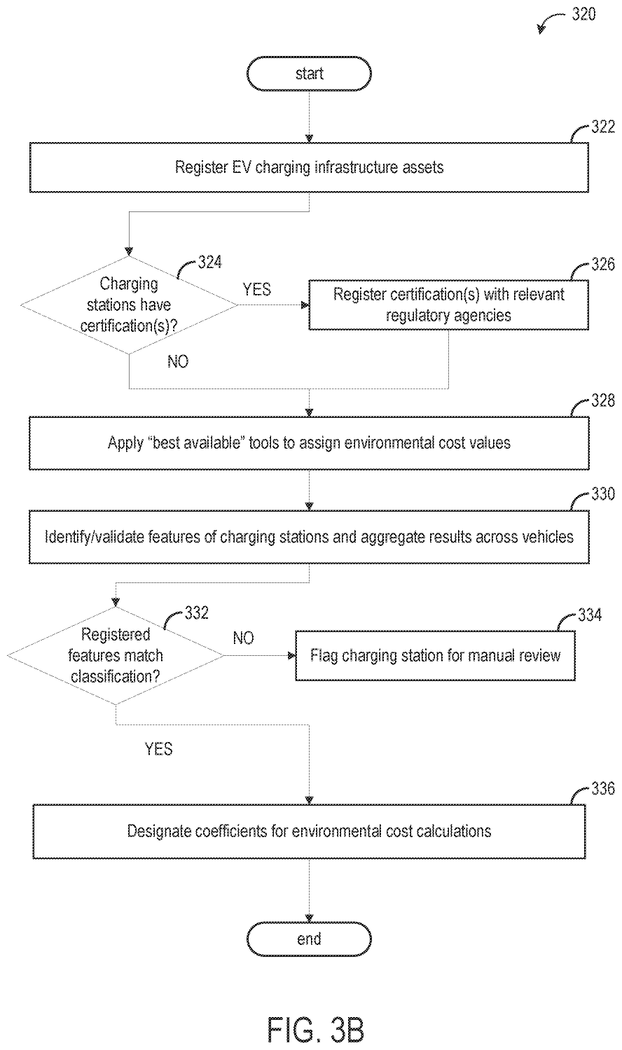

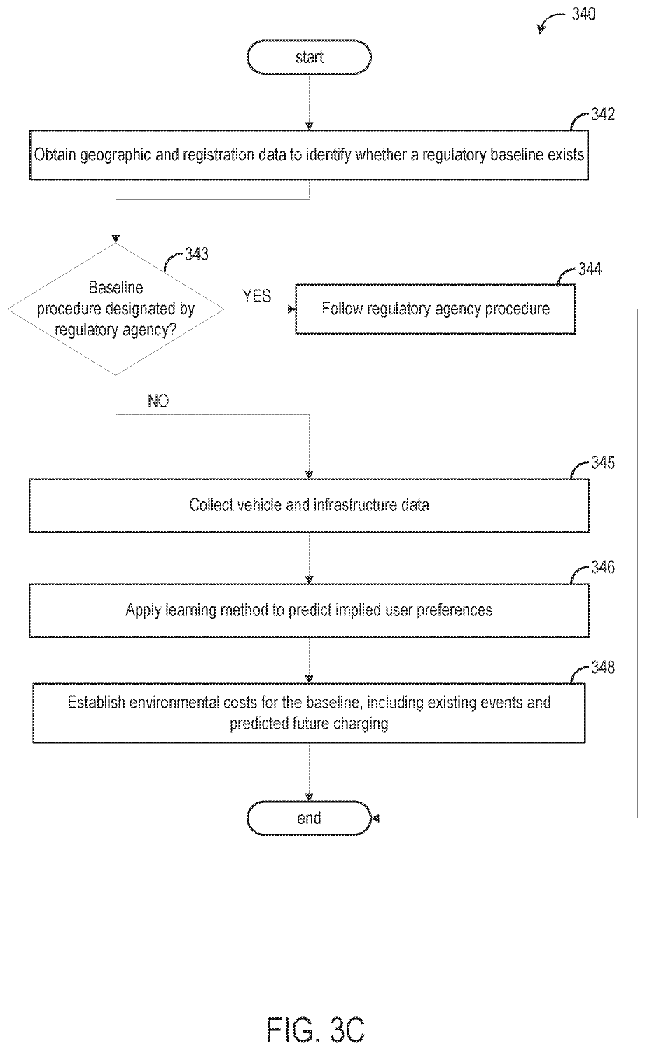

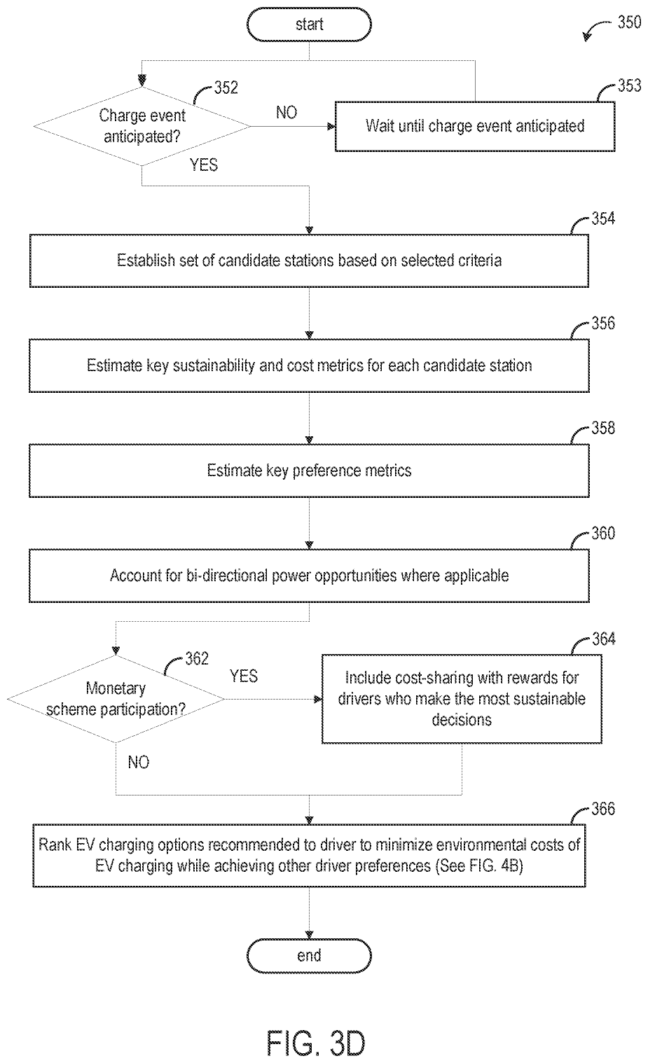

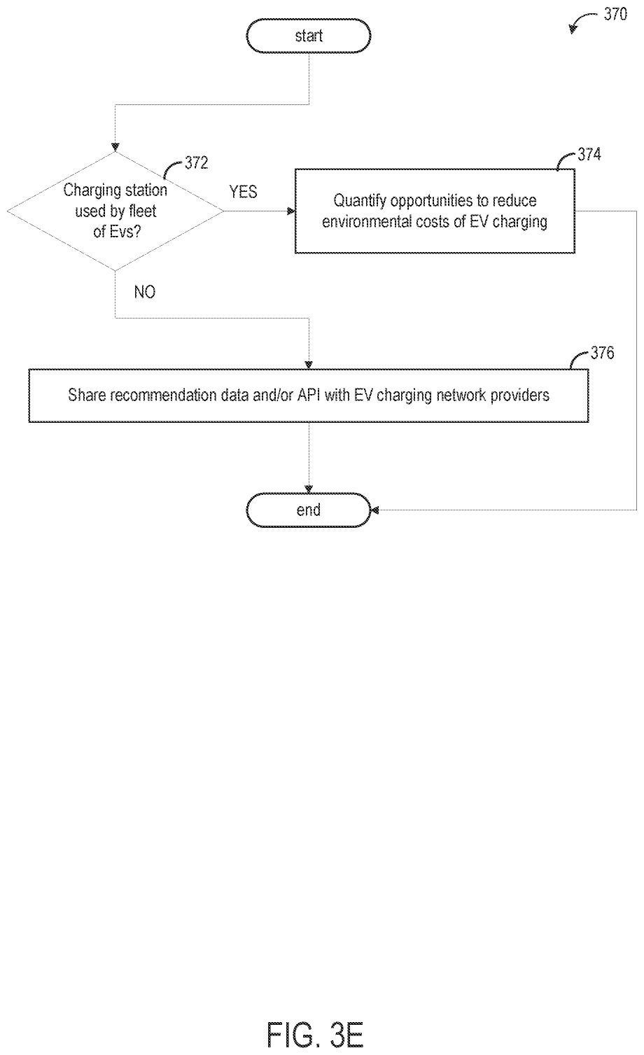

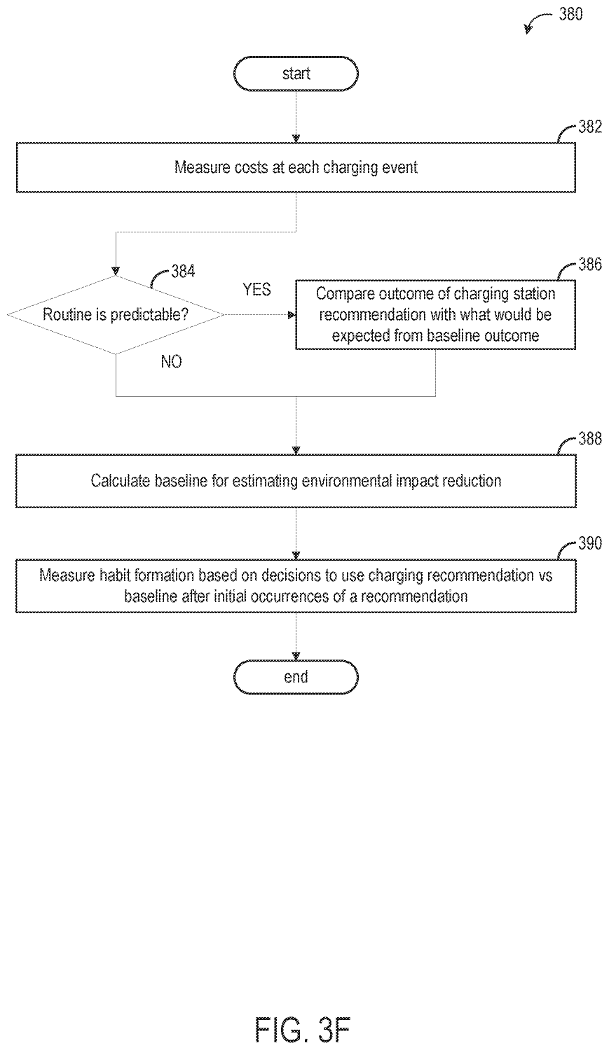

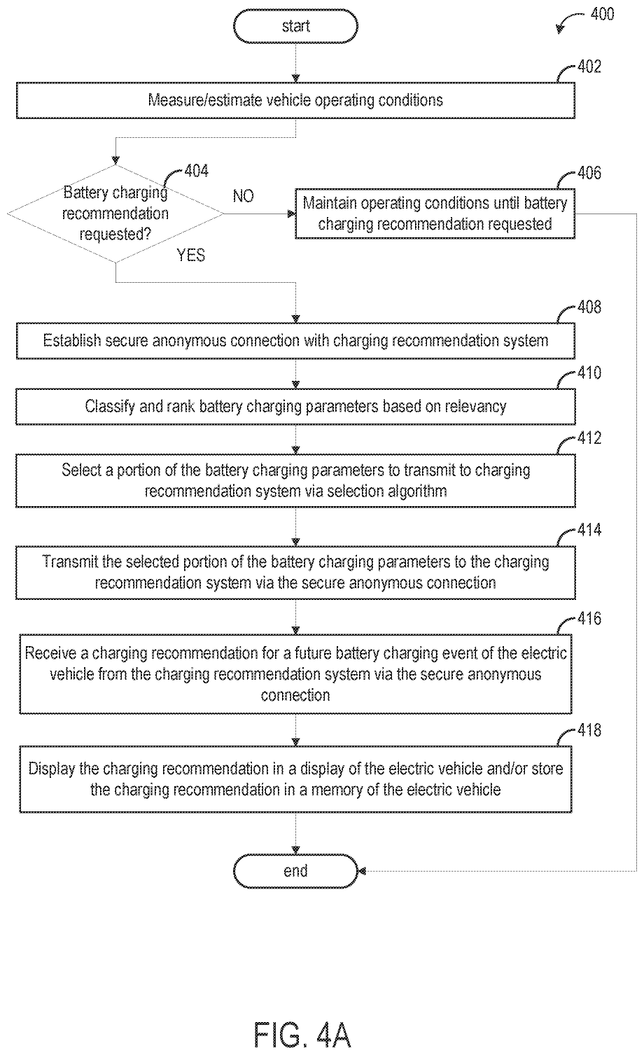

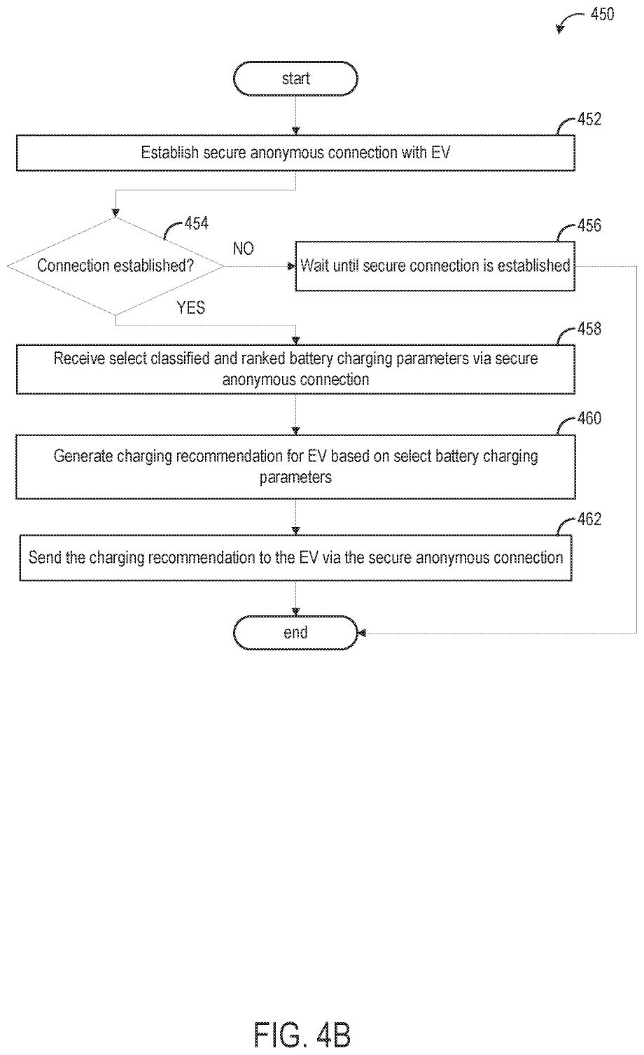

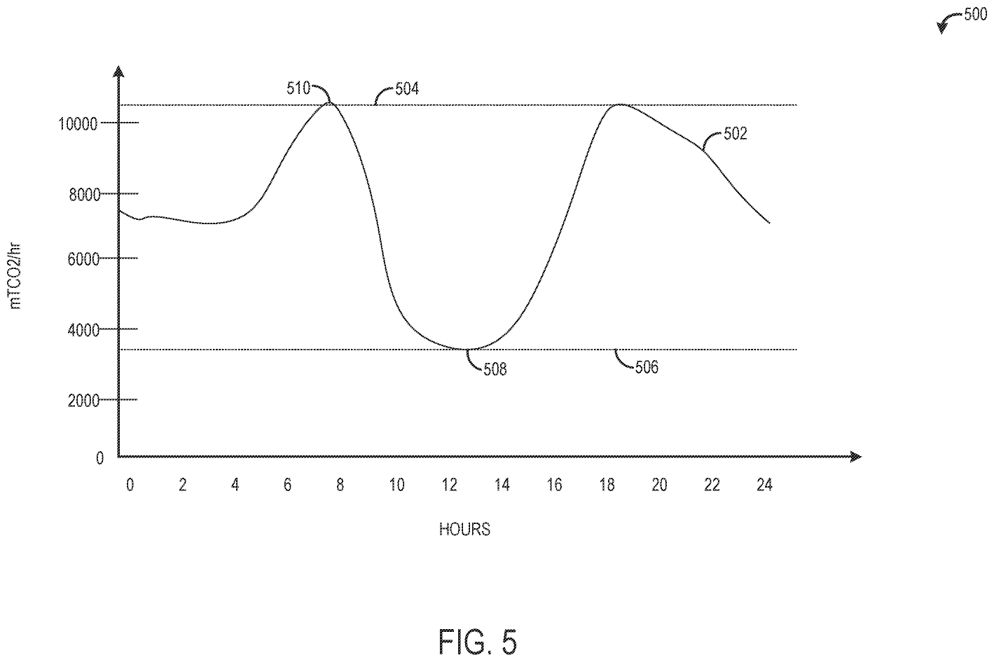

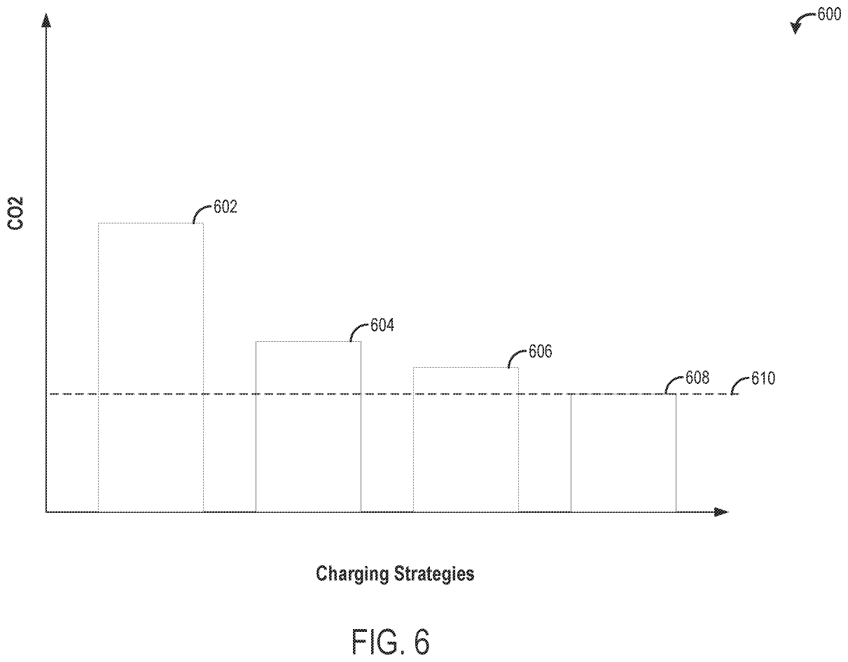

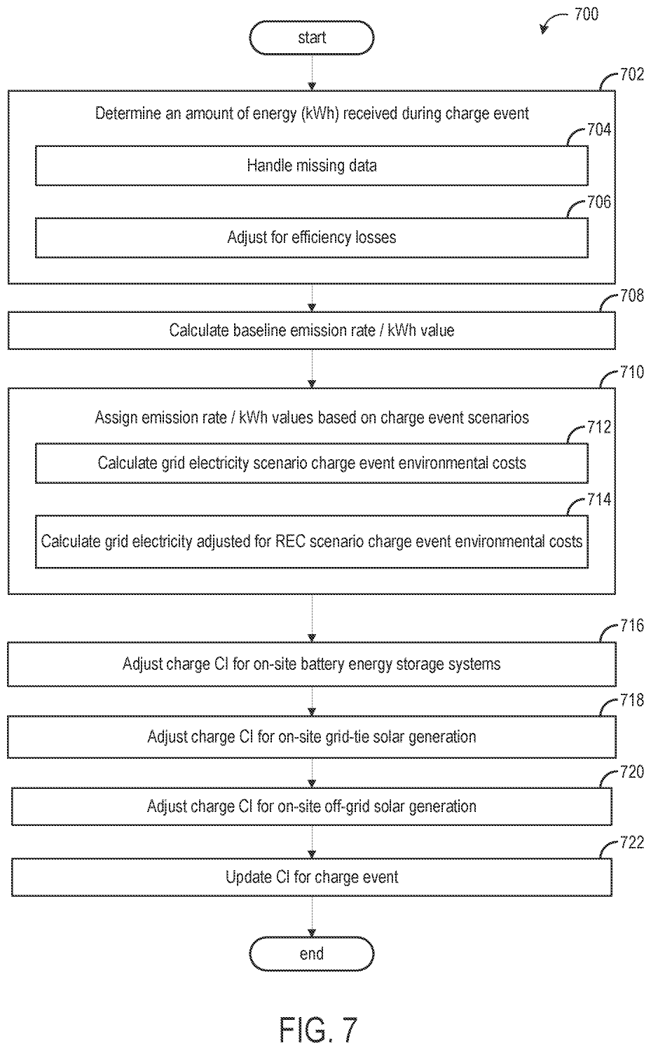

An EV may communicate and exchange information with a cloud-based charging recommendation system within an electric vehicle charging system, such as the charging system of FIG. 1. FIG. 2 shows components of the EV and the cloud-based charging recommendation system that are used to generate and exchange data to support the charging recommendations. A framework may be developed for estimating a carbon footprint of an EV and encouraging EV drivers and owners to seek energy from renewable sources, by following the procedure outlined in FIG. 3A. The procedure may include assessing sustainable options of a charging infrastructure, by following the method outlined in FIG. 3B; measuring a baseline of environmental costs of EV charging habits, by following the method outlined in FIG. 3C; identifying and encouraging drivers to use more sustainable EV charging options, by following the method outlined in FIG. 3D; identifying and encouraging charging stations to supply more sustainable charging options, by following the method outlined in FIG. 3E; measuring an effect of the charging recommendations, by following the method outlined in FIG. 3F; and creating a database of carbon offset opportunities. The charging recommendations may be generated from battery charging parameters of the EV as described in relation to FIG. 4B, which may be selected and sent to the charging recommendation system as described in relation to FIG. 4A. FIG. 5 shows a graph illustrating a varying amount of carbon released in the production of energy from different sources supplied to a grid at different times during a typical day. In some examples, the charging recommendation system may send a fleet owner or charging station owner charging strategy options in the form of a bar chart, as shown in FIG. 6. The charging recommendations may be based partly on an environmental cost value assigned to a charge event, which may be calculated by following one or more steps of the method shown in FIG. 7.

FIG. 1 shows an electric vehicle charging system 100, including an EV 102, a plurality of charging stations 120, 122, and 124, and a charging recommendation system 106. EV 102 may be a plugin hybrid vehicle, a range extended hybrid vehicle, an electric traction or battery or plugin vehicle, or a different type of electric vehicle. EV 102 may be a car, light or heavy truck, bus, or any other type of vehicle operated on roadways and charged via an electric charging station. In some embodiments, EV 102 may be owned and operated by a user (e.g., a driver). In other embodiments, EV 102 may be owned by a first party and operated by a second party. In various embodiments, EV 102 may be owned by a company and operated by an employee of the company. For example, EV 102 may be one of a plurality of EVs of a vehicle fleet 104, where vehicle fleet 104 is managed by the company (e.g., rental cars, delivery vehicles, busses, etc.).

Charging stations 120, 122, and 124 may be installed at a residential home or outside a residential home, for example, at a public (e.g., non-networked) or private (e.g., networked) charging station. Charging stations 120, 122, and 124 may be connected to an electric grid 150. Electric grid 150 may receive power from a utility company 160. In various embodiments, utility company 160 may be a sole provider of electrical energy for a particular geographical region. In other embodiments, more than one utility company 160 may service a particular geographical region. The power received by electric grid 150 from utility company 160 may be generated at one or more energy sources 170 connected to utility company 160. The one or more energy sources 170 may include renewable energy sources (e.g., solar, wind, hydroelectric, nuclear, geothermal), and non-renewable energy sources (e.g., generated from fossil fuels).

During operation of electric grid 150, utility company 160 (or a plurality of utility companies 160) may coordinate a supply of available power to meet power demands of electric grid 150. Utility company 160 may determine an amount of electricity to supply to electric grid 150, and send a signal over the Internet to the one or more energy sources 170 requesting that the power generated by various power plants of the one or more energy sources 170 be increased or decreased. Utility company 160 may then transmit the increased or decreased power sent by the various power plants to electric grid 150, where the electricity may be accessed via charging stations 120, 122, and 124. Additionally, utility company 160 may implement Time of Use (TOU) rates for charging electric vehicles to encourage off-peak charging, thereby minimizing effects on electric grid 150. TOU rates may be fixed based on the time-of-day and/or the location, or TOU rates may be dynamic based on a current supply-demand situation and operating costs (e.g., grid load).

For example, during peak energy consumption times, utility company 160 may request that power generated by most or all of the energy sources 170 be increased. During non-peak times, utility company 160 may request that power generated by most or all of the energy sources 170 be decreased. During times when the sun is shining, utility company 160 may request that power generated by a solar energy source be increased, and that power generated from burning oil or coal be decreased. During seasons or times of high wind, utility company 160 may request that power generated by a wind farm be increased, and that power generated from burning oil or coal be decreased. Utility company 160 may implement TOU rates where a first price of electricity is offered during times when the sun is shining or during windy times, and a second price of electricity is offered during other times, where the first price may be lower than the second price to encourage drivers to charge EVs when the electricity can be provided by renewable sources rather than non-renewable sources. By encouraging the drivers to purchase electricity provided by renewable sources, money may be saved by utility company 160 (e.g., via tax or regulatory credits, or other incentives).

EV 102 and charging stations 120, 122, and 124 may be wirelessly connected to a cloud 108 (e.g., the Internet) via a wireless network 140. As such, EV 102 may be communicably coupled to each of charging stations 120, 122, and 124. A controller 105 of EV 102 may transmit information to and/or receive information from one or more of charging stations 120, 122, and 124. The information exchanged between EV 102 and the charging stations 120, 122, and 124 may include information about the one or more energy sources 170 used to generate the electricity supplied to the electric vehicle during a charge event. Information on renewable energy content and environmental impacts (including benefit relative to average or other options) may be made available by the charging recommendation system to be displayed by the recommendation system or devices sourcing the data from the system. . . . For example, an energy source 170 may be a renewable energy source, such as a wind energy source, a solar energy source, a biofuel source, a nuclear source, or a different renewable energy source. An energy source may also be a non-renewable energy source, such as an oil or coal burning plant. A charging station may offer electricity generated by a plurality of energy sources, including one or more renewable energy sources and/or one or more non-renewable energy sources. In some embodiments, the information exchanged between EV 102 and the charging stations 120, 122, and 124 may include a list of all energy sources 170 used to supply the electricity available at a relevant charging station. The list may include an indication of an amount or percentage of electricity that is generated by each energy source 170 on the list of energy sources 170.

The information exchanged between EV 102 and the charging stations 120, 122, and 124 may include information associated with a cost of electricity provided to EV 102 during a charge event. For example, a first energy source may supply electricity at a first cost; a second energy source may supply electricity at a second cost which may be different from the first cost; a third energy source may supply electricity at a third cost which may be different from either or both of the first and second costs; and so on. As a result of the different costs of electricity generated by different energy sources, charging stations may offer electricity at different prices.

The information exchanged may be used by a driver of EV 102 to select a desired charging station to recharge EV 102. For example, the driver may use the information to select a charging station that supplies electricity generated from renewable sources, as opposed to a charging station that supplies electricity generated from non-renewable sources. Further, as described in greater detail below, to facilitate the driver in making a decision regarding a charging station to select, charging recommendation system 106 may provide a recommendation to the driver regarding a preferable charging station to select based on comparing environmental impacts per kWh of different charging stations. In addition to the information described above retrieved from the charging stations regarding the energy sources 170, the recommendation may be based on various other factors. In various embodiments, charging recommendation system 106 may provide the recommendation based on a ranking of charging stations 120, 122, and 124, where the ranking is based on information received from charging stations 120, 122, and 124 with respect to energy sources, electricity costs, and the other information. The other information may include vehicle or driver information/priorities received from EV 102 and/or a driving profile of a driver of EV 102.

As an example, a driver of EV 102 may be travelling along a route including charging station 120, charging station 122, and charging station 124, which may each be located in different regions along the route. Charging station 120, charging station 122, and charging station 124 may supply electricity generated by a same energy source 170, or different energy sources 170. Charging stations 120, 122, and 124 may deviate from the route by different distances (and corresponding energy consumption). Charging stations 120, 122, and 124 may have different station footprints (land use impacts) in different built environments, where large footprints (esp. for example a new parking lot with no other use) may take up valuable space and drive car traffic to a location where surrounding roads have limited vehicle capacity thus can become easily congested. Charging stations 120, 122, and 124 may further have differentiating attributes such as use of RECs and infrastructure differences such as on-site batteries, renewable energy production sources, power output and efficiency losses, and electronic displays like advertising screens, with each attribute contributing to positive and/or negative environmental impacts per kWh.

The driver may wish to select one of charging station 120, charging station 122, or charging station 124 to charge EV 102. Controller 105 of EV 102 may request a charging recommendation from charging recommendation system 106 via wireless network 140 and cloud 108. Charging recommendation system 106 may retrieve information from charging station 120 indicating that charging station 120 offers electricity generated from the local grid mix, where the electricity is offered at a first price. Charging recommendation system 106 may request charging information from charging station 122, which may indicate that charging station 122 also offers electricity generated from the local grid mix, but station attributes also include a small 10 kW on-site grid tie solar array with 20 kWh of on-site battery storage to mitigate peak loads and power on-site equipment like the charging station and a 25 inch advertising screen; where the electricity is offered at a second price. Charging recommendation system 106 may request charging information from charging station 124, which may send charging recommendation system 106 information indicating that charging station 124 offers electricity generated from an on-site 50 kW solar panel array with 100 kWh of on-site battery storage, where the electricity is offered at a third price. Charging recommendation system 106 may request information from controller 105 about EV 102. Information about EV 102 will include intended route and/or potential destinations near charging stations 120, 122, and 124, to assess expected additional driving distance and energy used to reach each charging stations 120, 122, and 124, which contributes to environmental impacts of each of these three options. The information about EV 102 may include information about one or more incentive programs EV 102 participates in for reducing the carbon footprint of EV 102. Charging recommendation system 106 may request information from controller 105 about the driver of EV 102, such as preferences for a stopping point, common routes taken, historical driving data, and the like. Charging recommendation system 106 may process the information received from charging station 120, charging station 122, charging station 124, and controller 105 to determine a charging recommendation for EV 102. The charging recommendation may be displayed on a display of EV 102 and/or in the connected vehicle mobile application, from which the driver may select a desired charging station.

The charging recommendation may recommend charging station 124 for charging EV 102, based on charging station 124 energy sources and station attributes. As a result of an incentive of the driver to select a charging station that minimizes environmental impacts, the driver may select charging station 124 to charge EV 102.

An amount of charge expected for a remaining portion of a forecast period may also be a relevant variable in cases where charge speeds differ across stations, and total expected time charging differs, resulting in a different final SOC. For example, suppose Option (1) is an off-grid solar Level 1 charger. If the grid mix is already very clean at the charge time, perhaps Option (2) (e.g., a DC Fast charger) will result in the lowest emissions because it avoids an expected later charge at a higher-emission time of day.

Environmental impacts will depend on the rate of environmental impacts per kWh calculated from the summation of contributing factors including: energy source mix; on-site infrastructure components (manufacturing impacts—including factory production, transportation, installation, and end of life); ongoing infrastructure servicing (maintenance—use phase); dispensing power output rates (vehicle and infrastructure battery degradation and lifetime energy output of the infrastructure); operational power usage (operations); efficiency losses; local land use impacts (station footprint); and distance deviation from the vehicle's intended route.

Some of these contributing factors to environmental impacts of charging stations 120, 122, and 124 might be natively in the units a rate of a given impact per kWh, such as CO2/kWh from the energy mix at a given time.

Some contributing factors may represent energy consumption, such as electricity used by chargers including screens and other electronics, but cannot easily be attributed to a single charge event, as screens may be on even when no vehicles are charging. Such factors may be summed (e.g., kWh of energy consumed for these features, given grid mix when consumed) and then normalized by expected kWh charged over some period of time.

Other factors, such as manufacturing impacts of infrastructure components, might natively be computed as a total impact value, requiring an assumption of total lifetime kWh dispensed supported by the given infrastructure component. Purely for illustration purposes (real world magnitudes will certainly be different), a solar array installed at a charging station may be projected to generate 1 kWh over its lifetime that is charged to an EV, where the solar array has a life cycle cost of 50 g CO2. The life cycle manufacturing impact will be 50 g CO2/kWh. Variations may be possible in life cycle cost estimates, for example what might be expected for end of life (recycling).

Charging recommendation system 106 and databases 130 may be implemented over cloud 108 or a different computer network. For example, charging recommendation system 106 is shown in FIG. 1 as constituting a single entity, but it should be understood that charging recommendation system 106 may be distributed across multiple devices, such as across multiple servers.

Electric vehicle charging system 100 may include one or more external databases 130, which may store data used by charging recommendation system 106. Databases 130 may include information about various regulatory credits, tax credits, emissions trading schemes, carbon taxes, carbon pricing plans, low-carbon fuel standards, climate and/or economic models, OEM and/or manufacturer data for EVs and/or charging station equipment, and other types of data hosted on public or private servers. Charging infrastructure providers may provide and update station inventories of equipment with details such as capacities, manufacturers, or operational emissions data. Manufacturers may likewise provide product specification information and share any available life cycle analysis reporting. Vehicle sensors including cameras may validate information like on-site attributes, for example by classifying the presence of a solar array of a given capacity. Crowd-sourcing this information might function as well, for example using photos shared to charging recommendation system 106, including on-site labels detailing specifications of equipment.

For example, charging recommendation system 106 may access information from databases 130 regarding CARB's Low Carbon Fuel Standard (LCFS), Oregon's Clean Fuels Program, Washington's Clean Fuel Standard, and/or EPA upstream emissions standards. Life cycle analysis and environmental impact inventory databases like EcoInvent or regional environmental agency impact factors may be leveraged. The database may also provide preferred reference values and prescriptions for method selection (for example system boundaries) and parameters, such as from regulators and certifying agencies. Electric vehicle charging system 100 may rely at least partially on data retrieved from the one or more databases 130 to generate a recommendation for EV 102 with respect to a charging strategy. Charging recommendation system 106, via wireless network 140, may communicate the recommendation and elements of the data from databases 130 over the air to EV 102.

During a charge event, EV 102 may be coupled to a selected charging station 124 via a charging cable 114, and may receive electricity from charging station 124 via charging cable 114. The electricity received from charging station 124 may be supplied by electric grid 150. Additionally, the electricity, or a portion of the electricity, may be supplied by one or more solar arrays 154 electrically coupled to selected charging station 124. The one or more solar arrays 154 may be located at the charging station. For example, the one or more solar arrays 154 may be arranged on a solar canopy of the charging station. In some embodiments, the one or more solar arrays 154 may be grid-tie solar setups that are electrically coupled to electric grid 150, where energy generated at the one or more solar arrays 154 may be transferred to electric grid 150 under certain conditions. In other embodiments, the one or more solar arrays may be off-grid solar setups that are not electrically coupled to electric grid 150.

The electricity, or a portion of the electricity, may also be supplied by one or more behind-the-meter energy storage devices electrically coupled to charging station 124, such as an off-grid battery 152. Off-grid battery 152 may be used to store electricity generated by the one or more solar arrays 154 and/or electric grid 150. For example, electricity may be generated by the one or more solar arrays 154 during a first time period of the day (e.g., when the sun is shining), and not generated by the one or more solar arrays 154 during a second time period of the day (e.g., when the sun is not shining). When a charge event occurs during the first time period, the electricity used to charge EV 102 may be generated by the one or more solar arrays 154. When a charge event occurs during the second time period, the electricity used to charge EV 102 may be received from electric grid 150.

The electricity generated by the one or more solar arrays 154 may be low-carbon electricity, meaning that an amount of carbon released during generation of the electricity is low. The electricity received from electric grid 150 may be high-carbon electricity, meaning that an amount of carbon released during generation of the electricity is high. For example, the electricity received from electric grid 150 may be generated as a result of burning a fossil fuel such as oil, gas, or coal. Various incentives may exist for charging EV 102 using low-carbon electricity as opposed to high-carbon electricity, or for charging station 124 to provide low-carbon electricity as opposed to high-carbon electricity. For example, EV 102 may be owned by a company that purchases RECs, and may therefore incentivize drivers to reduce the carbon footprint of EV 102. Charging station 124 may also purchase RECs, or benefit from various tax and/or regulatory credits associated with supplying renewable energy. As a result, charging station 124 may store the low-carbon electricity generated by the one or more solar arrays 154 in off-grid battery 152 to be available for charging electric vehicles.

Because some energy sources 170 supplying electricity to electric grid 150 may be renewable and other energy sources 170 supplying electricity to electric grid 150 may be non-renewable, the carbon footprint of the electricity received from electric grid 150 may vary.

Referring briefly to FIG. 5, an exemplary carbon generation graph 500 shows an aggregate amount of carbon released into the atmosphere for electricity supplied via an electric grid, from all energy sources, over the course of a typical day. A vertical axis of carbon generation graph 500 shows a carbon generation rate measured in metric tons of CO₂ per hour (mTCO₂/hr), and a horizontal axis shows a time of day measured in hours. Carbon generation graph 500 includes one plot, a line 502 indicating a change in the carbon generation rate over the course of a 24 hour period.

As indicated by line 502, the carbon generation rate varies within a range. An upper bound of the range (approximately 10200 mTCO₂/hr) is indicated by a dotted line 504, and a lower bound of the range (approximately 3500 mTCO₂/hr) is indicated by a dotted line 506. Thus, a carbon footprint of the electricity supplied by the electric grid may be nearly three times greater at certain times of the day (e.g., peak consumption hours) than at other times of the day (e.g., low consumption times).

Specifically, power received from the electric grid when charging an EV at midnight (time=0) on a typical day generates roughly 7500 mTCO₂/hr, released at a time of its generation (e.g., at an earlier time). However, power received from the electric grid at 8:00 in the morning generates roughly 10200 mTCO₂/hr during its generation, as indicated by a point 510 on line 502. Thus, a greater amount of carbon is released into the atmosphere if an EV recharges at 8 AM than if the EV recharges at midnight. In contrast, power received from the electric grid at 12:00 noon (a low consumption time) generates roughly 3500 mTCO₂/hr, as indicated by a point 508 on line 502, which is substantially less than at 8:00 AM or at 6:00 PM.

One reason that the amount of carbon produced by electricity received from the electric grid at noon is less than the amount of carbon produced by electricity received from the electric grid at 8:00 AM and at 6:00 PM may be that a mix of energy supplied to the electric grid at noon may include a greater percentage of energy generated from solar panels, which may produce more electricity at times when the sun is high in the sky. Another reason may be that when power is received from the grid at high-consumption times of the day, a utility company (e.g., utility company 160) may rely on a greater percentage of energy from less desirable (e.g., fossil fuel) sources to ensure that a constant and adequate supply of electricity is available to its customers. In other words, when demand is low, the utility company may generate or purchase energy from more sustainable sources, and when demand is high, the utility company may generate or purchase energy from any or all sources, including less sustainable sources. Thus, a carbon footprint of an EV may be substantially reduced by selectively recharging the EV at low consumption times and/or at times when a greater amount of energy is being generated by renewable sources.

Returning now to FIG. 1, during charging, EV 102 may exchange information of the charge event (e.g., battery charging parameters, charging data and feedback, vehicle system data) with charging station 124 via charging cable 114. In some embodiments, EV 102 may additionally or alternatively exchange the information with selected charging station 124 directly over wireless network 140, or via cloud 108 over wireless network 140. In other embodiments, EV 102 may additionally or alternatively communicate and/or exchange information with selected charging station 124 via radio frequency (RF) signals. For example, EV 102 may include a first RF transceiver 110, and charging station 124 may include a second RF transceiver 112, where information of EV 102 may be sent from first RF transceiver 110 to second RF transceiver 112, and/or information of selected charging station 124 may be sent from second RF transceiver 112 to first RF transceiver 110. For example, the information may be exchanged via a wireless electronic device interconnector, such as a Bluetooth® connection. In other embodiments, EV 102 may communicate and exchange information with selected charging station 124 via a wired connection other than charging cable 114, or via a different type of wireless communication.

Charging station 124 may transmit or communicate the charge event information to charging recommendation system 106. For example, charging recommendation system 106 may request the charge event information from charging station 124. The charge event information may be used by charging recommendation system 106 to increase a performance of a charging recommendation engine of charging recommendation system 106. For example, the charging recommendation engine may aggregate information sent from various charging stations and various EVs. The aggregated information may be used to establish baseline environmental costs of EV charging habits and estimate a relative effectiveness of various charging strategies at reducing the carbon footprints of the various EVs. The aggregated information may be used to identify EVs or portions of an EV population that might benefit from more effective charging recommendations, and/or encourage drivers of EVs and operators of charging stations to supply more sustainable EV charging options.

Referring now to FIG. 2, a schematic diagram 200 shows EV 102 in communication with charging recommendation system 106 via cloud 108 of the electric vehicle charging system of FIG. 1. Various components of charging recommendation system 106 and various components of EV 102 relevant to charging EV 102 are shown.

Charging recommendation system 106 includes at least a processor 222, a memory 224, and a recommendation engine 227. As described herein, a memory (such as memory 224) may include one or more data storage structures, such as optical memory devices, magnetic memory devices, or solid-state memory devices, for storing programs and routines executed by a processor (e.g., processor 222) to carry out various functionalities disclosed herein. Memory may include any desired type of volatile and/or non-volatile memory such as, for example, static random access memory (SRAM), dynamic random access memory (DRAM), flash memory, read-only memory (ROM), etc. Processor 222, as well as other processors described herein, may be any suitable processor, processing unit, or microprocessor, or a multi-processor system including one or more additional processors that are identical or similar to each other and that are communicatively coupled via an interconnection bus.

Charging recommendation system 106 may facilitate transmission of charging strategy recommendations to a plurality of electric vehicles (such as EV 102) via cloud 108. Specifically, recommendation engine 227 may receive a plurality of battery charging parameters 216 from EV 102 via cloud 108. Recommendation engine 227 may determine a charging recommendation for a most suitable charging station based on the received battery charging parameters 216, and transmit the recommendation to EV 102. Generation of the charging recommendation is described in greater detail below in reference to FIGS. 3A-3F and 4A-4B.

Memory 224 may include a recommendation database 225, which may store charging recommendation data received at and/or generated by recommendation engine 227. The charging recommendation data may include, for example, sets of battery charging parameters 216 received from EV 102 when requests are made for a charging recommendation. The charging recommendation data may include a list of charging recommendations made and transmitted to EV 102. If a driver of EV 102 selects a charging recommendation made by recommendation engine 227, the selection may be transmitted back to charging recommendation system 106 and stored in recommendation database 225. Additionally, if the driver recharges EV 102 at a charging station recommended by recommendation engine 227, the selected charging station may be transmitted back to charging recommendation system 106 and stored in recommendation database 225.

Additionally, memory 224 may include an infrastructure assets database 226, which may store records of various charging infrastructure assets within the electric vehicle charging system 100. Infrastructure assets database 226 may include details on charging infrastructure present at various charging stations. For example, infrastructure assets database 226 may include data regarding which charging stations have solar arrays installed, or on-site battery storage, etc. The data may be used by recommendation engine 227 to generate charging recommendations.

EV 102 includes at least one energy storage device 204, such as a traction battery, that stores electricity used to propel wheels of EV 102. The electricity may be received by energy storage device 204 when EV 102 is charged, for example, at a charging station (e.g., charging station 124), or when plugged into an electric grid (e.g., electric grid 150) via a power outlet such as at a home of a driver of EV 102. In some embodiments, energy storage device 204 may include an energy storage device controller, which may provide charge balancing between various storage elements (e.g., battery cells) of energy storage device 204 and communication with other vehicle controllers. A flow of power into and out of electric energy storage device 204 may also be controlled by the energy storage device controller, or by a power distribution module of the energy storage device controller of energy storage device 204. Existing and future battery chemistries can be expected to evolve, including energy storage device 204 on vehicle EV 102 and off-grid battery 152. Relevant metrics that effect life cycle impacts may include the use of recycled content in manufacturing; end-of-life recycling and recyclability; use phase efficiency losses, electricity consumption, maintenance requirements; physical footprint; equipment lifetime; and any other localized impacts.

EV 102 may include an onboard navigation system 206. Onboard navigation system may provide route information to the driver of EV 102, including a current location of EV 102 and a destination of EV 102. For example, when operating EV 102, the driver may enter a destination into onboard navigation system 206. Onboard navigation system 206 may indicate one or more routes from the current location to the destination on a map displayed by onboard navigation system 206. In various embodiments, the map may be displayed on a screen of a display of onboard navigation system 206, such as a dashboard display. The driver may select a route of the one or more routes, and onboard navigation system 206 may provide instructions to the driver and/or indicate a progress of EV towards the destination on the map. Onboard navigation system 206 may additionally display information such as an estimated distance to the destination, an estimated time of arrival at the destination based on a speed of the vehicle, indications of traffic on the route, and/or other information of use to the driver.

In some embodiments, onboard navigation system 206 may not be included in EV 102, and onboard navigation system 206 may be an independent navigation system communicably coupled to EV 102. For example, onboard navigation system 206 may be an application (e.g., such as Google Maps) installed on a mobile device communicably coupled to EV 102. The independent navigation system may be linked to one or more displays of EV 102, where route information is displayed on the one or more displays, and/or the route information may be displayed on the mobile device (e.g., in a user interface of the application).

EV 102 may include a communication module 208, which may control a communication between one or more controllers of EV 102 and external elements of infrastructure. The external elements of infrastructure may include one or more charging stations, such as charging stations 120, 122, and 124. The communication may include wired communication, for example, via a cable communicatively coupling EV 102 with a charging station, or the communication may include wireless communication, for example, via a modem, or via a radio frequency (RF) transceiver. For example, EV 102 may communicate with a charging station (for example, during a charge event) via Bluetooth®, or via a different RF protocol.

Communication module 208 may facilitate transmission of various types of electronic data within and/or among one or more systems of EV 102 and/or electric vehicle charging system 100 of FIG. 1. In particular, communication module 208 may facilitate wirelessly receiving charging strategy recommendations transmitted from charging recommendation system 106 via cloud 108, as described above. For example, EV 102 may send vehicle location and route information to charging recommendation system 106, and charging recommendation system 106 may send EV 102 a recommendation regarding where to charge EV 102. The location and route information may be retrieved from onboard navigation system 206. As described in greater detail below, the recommendation may be based on a sustainability of energy sources of electricity provided at a plurality of charging stations available to EV 102. For example, the charging stations available to EV 102 may be located along the route of EV 102.

Communication module 208 may also facilitate wireless transmission of electronic data between EV 102 and a charging station, such as charging stations 120, 122, and 124 of FIG. 1. Communication via the communication module can be implemented using one or more protocols. The communication module can include a wired interface (e.g., a data bus, a Universal Serial Bus (USB) connection, etc.) and/or a wireless interface (e.g., radio frequency, infrared, near field communication (NFC), etc.). For example, the communication module may communicate via wired local area network (LAN), wireless LAN, wide area network (WAN), etc. using any past, present, or future communication protocol (e.g., BLUETOOTH™M, USB 2.0, USB 3.0, etc.).

Additionally, communication module 208 may be configured to encrypt communications transmitted from EV 102 to recipients of the communications, such as charging recommendation system 106, and decrypt communications received at EV 102 from transmitters including charging recommendation system 106. In other words, communication module 208 may establish a secure, anonymous connection with charging recommendation system 106; subsequently transmit information to charging recommendation system 106 via the secure anonymous connection; and receive information from charging recommendation system 106 via the secure anonymous connection. The information sent to charging recommendation system 106 may include a plurality of battery charging recommendation, and the information received from charging recommendation system 106 may include a charging recommendation, as described in greater detail below. By sending and receiving encrypted communications via the secure anonymous connection, a privacy of data of EV 102, a driver of EV 102, and/or an owner of EV 102 may be protected. For example, the data may include proprietary information about the owner or driver, a location or route of the driver, historical driving habits of the driver, information about a fleet of EVs owned and managed by the owner, a participation of the owner in one or more incentive programs, and other data, which if unencrypted could be used by a malicious third party interceptor to achieve various undesirable marketing, business, or other goals.

EV 102 may include a charging recommendation UI 209. In various embodiments, charging recommendation UI 209 may include a display (e.g., a screen) mounted on a dashboard of EV 102, and one or more controls (e.g., such as buttons) for navigating and/or selecting items displayed in charging recommendation UI 209. In some embodiments, the display may be a touchscreen display, where the one or more controls are integrated into the display and a user (e.g., an operator of EV 102) may navigate and/or select items by selecting graphical control elements displayed on the touchscreen display. In some embodiments, charging recommendation UI 209 may share components with or be integrated into a different UI or display of EV 102. For example, charging recommendation UI 209 may share components with or be integrated into onboard navigation system 206.

For example, the user may request a charging recommendation from charging recommendation system 106. Information including a current location and destination of EV 102 may be sent to charging recommendation system 106. Charging recommendation system 106 may generate one or more charging recommendations for charging stations where EV 102 may recharge energy storage device 204 based on the information. The charging recommendation(s) may be displayed in charging recommendation UI 209. For example, the charging recommendation(s) may be displayed as a list of candidate charging stations for recharging EV 102. Using charging recommendation UI 209, the user may navigate through the list of candidate charging stations using the one or more controls. The user may select a desired charging station for charging EV 102 from the list of candidate charging stations using the one or more controls.

By selecting the desired charging station, one or more actions may be performed. The one or more actions may be automatically performed, or the user may be prompted to perform the one or more actions. In one example, when the desired charging station is selected, an address of the desired charging station may be entered as a destination into onboard navigation system 206, whereby EV 102 may be routed to the desired charging station. In another example, when the desired charging station is selected, additional information about the desired charging station or electricity supplied by the desired charging station may be displayed in charging recommendation UI 209. It should be appreciated that the examples provided herein are for illustrative purposes, and other, different types of information displays and/or actions may be supported without departing from the scope of this disclosure.

In some embodiments, charging recommendation UI 209 may include a map-based display, where the candidate charging stations are displayed on a map. The candidate charging stations displayed on the map may be selectable, where the one or more actions may be performed as a result of selecting a desired charging station on the map. In other embodiments, charging recommendation UI 209 may include or be integrated into a map of onboard navigation system 206. For example, in response to the user requesting a charging recommendation from charging recommendation system 106, the candidate charging stations may be displayed in the map of onboard navigation system 206, and the user may select the desired charging station as a destination in onboard navigation system 206.

Controller 105 may include one or more processors 212 and a memory 214. Memory 214 may store a plurality of battery charging parameters 216. Battery charging parameters 216 may be used by charging recommendation engine 227 to generate a charging recommendation for EV 102. Battery charging parameters 216 may include charge event parameters, such as charging time information, including starting times and ending times of charge events, and ignition-on/ignition-off times; a charging energy source type, a cost of electricity used to charge EV 102 including a TOU rate, a charge amount, a current state of charge (SOC), a SOC at the charge start time, a SOC at the charge end time, and/or other parameters. Battery charging parameters 216 may additionally include charging strategy parameters, which may be used by charging recommendation system 106 to aid a driver of EV 102 in selecting a suitable charging station. The charging strategy parameters may include a battery type, a compatible charger type, location information of EV 102, such as a current location, a previous location, and/or a future destination, which may be accessed from navigation system 206; a current time of day or season; a current SOC; historical data including driver preferences for stopping locations and times, historical price information, and historical route information; cost share rewards or other incentives provided to drivers of EV 102 based on monetary schemes (e.g., fleet low carbon credits, public carbon tax, rewards points granted by an OEM or owner of EV 102, RECs purchased by the OEM or EV network to match electricity charged in certain geographic regions; and/or other parameters.

Controller 105 may also include various modules for processing and/or analyzing data relating to charging recommendations, such as a charge event prediction module 218 and a charging parameter ranking module 220. Charge event prediction module 218 may include one or more prediction models that may output a predicted future charge event based on vehicle and/or driver data. For example, the one or more prediction models may predict a time or time window during which the vehicle may be recharged, based on data such as a current charge of energy storage device 204; a current route of the vehicle retrieved from onboard navigation system 206; historical driving data of the driver; previous/historical charge event data of the vehicle; and/or other factors (e.g., other battery charging parameters 216). In various embodiments, controller 105 may use the predicted future charge event to determine whether and when to send a request to charging recommendation system 106 for a charging recommendation for EV 102. For example, the charging recommendation may be requested at a certain time (e.g., 1 hour) prior to the predicted charge event, or the charging recommendation may be requested prior to EV 102 reaching a location (e.g., such as a deviation from a route of EV 102 to access a charging station).

Charging parameter ranking module 220 may include a selection algorithm that classifies and ranks a relevance of the battery charging parameters for communication with charging recommendation system 106. The relevance of a battery charging parameter 216 may be correlated with a priority of the battery charging parameter 216 from the point of view of the driver of EV 102.

For example, in some embodiments, not all battery charging parameters 216 may be used to generate a charging recommendation for EV 102. In a first set of circumstances, a first set of battery charging parameters 216 may be used to generate a first charging recommendation. In a second set of circumstances, a second set of battery charging parameters 216 may be used to generate a second, different charging recommendation, where the second set of battery charging parameters 216 and the second charging recommendation are different from the first set of battery charging parameters 216 and the first charging recommendation. For example, in the first set of circumstances, energy storage device 204 may have a low SOC, whereby a driver of EV 102 may not wish to travel far before recharging energy storage device 204. In the second set of circumstances, energy storage device 204 may have a higher SOC, whereby a driver of EV 102 may wish to plan where to recharge energy storage device 204 at a later time. In the first set of circumstances, a sustainability of an energy source of electricity at a charging station may be a low priority of the driver. In the second set of circumstances, the sustainability of an energy source of electricity at a charging station may be a higher priority of the driver, where the driver may be willing to travel further or deviate more from a route of EV 102 to recharge energy storage device 204 with electricity derived from renewable sources.

As a result of the low SOC being a high priority of the driver in the first set of circumstances, the first charging recommendation may rely on a smaller set of battery charging parameters 216 than the second charging recommendation. In one example, when requesting the first charging recommendation, charging parameter ranking module 220 may assign a high ranking to select battery charging parameters 216, such as a location of EV 102, a destination of EV 102, and the SOC of energy storage device 204, and may assign a lower ranking to other battery charging parameters 216. As a result of the higher ranking of the location, the destination, and the SOC, communication module 208 may send the location, the destination, and the SOC (e.g., the first set of battery charging parameters 216) to charging recommendation system 106, and may not send other, lower ranking battery charging parameters 216. Charging recommendation system 106 may generate the first charging recommendation based on the location, the destination, and the SOC, since in the first set of circumstances the driver may select a closest charging station, and may not consider an energy source of the closest charging station.

As a result of the SOC not being low in the second set of circumstances, the second charging recommendation may rely on a larger set of battery charging parameters 216 (e.g., the second set of battery charging parameters 216) than the first charging recommendation. When requesting the second charging recommendation, charging parameter ranking module 220 may assign a high ranking to a different set of select battery charging parameters 216. The different set of select battery charging parameters 216 may include, in addition to the location of EV 102, the destination of EV 102, and the SOC of energy storage device 204, information about incentives for charging EV 102 with electricity from renewable energy sources, such as RECs and regulatory and/or tax credits; driver profile information, which may include driver preferences for recharge times and/or stopping points along a route; additional route information, for example, if a charging strategy may be requested for a plurality of anticipated charge events over a multi-day period of time; and/or other information. As a result of the higher ranking being assigned to the larger set of battery charging parameters 216 by charging parameter ranking module 220, communication module 208 may send the larger, second set of charging parameters 216 to charging recommendation system 106. Charging recommendation system 106 may generate the second charging recommendation based on the larger set of battery charging parameters 216.

Further, charging recommendation system 106 may generate the second charging recommendation based on relative rankings assigned to each battery charging parameter 216 of the larger set of battery charging parameters 216. In other words, the second charging recommendation may vary as the relative rankings assigned to each battery charging parameter 216 increase or decrease as the second set of circumstances changes. Thus, a different second charging recommendation may be generated by charging recommendation system 106 depending on how the relative priorities of the driver change.

In this way, a charging recommendation may be generated based on a set of battery charging parameters 216 that may vary in size and priority, where a number of battery charging parameters 216 may depend on the rankings of the battery charging parameters 216 assigned by charging parameter ranking module 220. A first set of rankings may result in one charging recommendation based on a first number of battery charging parameters, and a second set of rankings may result in a different charging recommendation based on a second number of battery charging parameters. By using charging parameter ranking module 220 to select a suitable number of battery charging parameters 216, and to indicate (e.g., via the rankings) relative priorities of the selected battery charging parameters 216, a customized charging recommendation may be generated by charging recommendation system 106 based on the relative priorities.

Further, if the customized charging recommendation is followed by the driver, feedback may be sent from communication module 208 to charging recommendation system 106 which may be stored in recommendation database 225 and used to increase a specificity of future charging recommendations. The customized charging recommendation may have a higher probability of being followed by the driver, thereby increasing adoption of charging recommendation system 106. Additionally, the battery charging parameters 216 on which a customized charging recommendation is made may be stored and tracked by charging recommendation system 106, and used to increase a success of recommendation engine 227 at meeting demands of electric vehicle drivers served by charging recommendation system 106. By increasing the success of recommendation engine 227 at meeting the demands of the electric vehicle drivers, an overall consumption of energy generated from non-renewable sources may be reduced, lowering carbon footprints of EVs served by charging recommendation system 106 and an overall amount of carbon released into the atmosphere in an energy-generating region where the EVs operate. Further, increasing the success of recommendation engine 227 may foster the development of a virtuous cycle, whereby as a usage of charging recommendation system 106 increases, via the charging recommendations, additional incentives may be created for drivers to seek sustainable sources of electricity for recharging EVs and for charging stations to supply more electricity from sustainable sources.

FIG. 3A shows a high-level method 300 for implementing a charging recommendation system for electric vehicles, such as charging recommendation system 106. In the context described in relation to FIGS. 1 and 2, a successful implementation and/or operation of the charging recommendation system may depend on a development of a framework to collect, manage, and store information to support the generation of charging recommendations. For example, the development of the framework may include aggregating data from a plurality of different sources, and analyzing the data to discover patterns that may be exploited via the charging recommendations. Method 300 outlines an overall process for developing the framework, the details of which are described in lower-level methods of FIGS. 3B-3F.

Method 300 begins at 302, where method 300 includes assessing sustainable charging options within a charging infrastructure. Assessing the sustainability charging options within the charging infrastructure is described below in reference to FIG. 3B.

At 304, method 300 includes measuring a baseline of environmental costs of EV charging habits. Measuring the baseline of environmental costs is described below in reference to FIG. 3C. At 306, method 300 includes identifying and encouraging drivers to use more sustainable EV charging options, by generating charging recommendations that may be sent to drivers of EVs. Identifying and encouraging drivers to use more sustainable EV charging options is described below in reference to FIG. 3D.

At 308, method 300 includes identifying and encouraging charging stations to supply more sustainable EV charging. Identifying and encouraging charging stations to supply more sustainable EV charging is described below in reference to FIG. 3E.

At 310, method 300 includes measuring an effect of interventions, compared with the baseline calculated at 304. Measuring the effect of interventions compared with the baseline is described below in reference to FIG. 3F.

At 312, method 300 includes creating a database, and populating the database with proposed carbon offset opportunities that are measurable and local to a decision-maker. For example, the decision-maker may be a driver, or a fleet manager, or an owner of the vehicle. Most EV charging options will produce environmental costs. Even charging locations with on-site battery storage and solar will include some life cycle environmental costs from production and transportation. An example of a carbon offset opportunity may include contributing to funding additional on-site solar energy at charging stations; expansion of nearby protected bicycle lanes; increasing or improving public transit options; and/or reducing an incremental cost of more sustainable city fleet vehicles. For fleet operators, presumably a focus of local offset funding might be on reducing a company's Scope 1-3 emissions. For example, Scope 1-3 emissions may be reduced by adding a parking lot solar array, upgrading to high-efficiency building appliances that may reduce long-run costs, procuring more EVs than planned, expanding employee transit/carpool programs, and the like.

Referring now to FIG. 3B, an exemplary method 320 is shown for assessing sustainable charging options within a charging recommendation system for electric vehicles, such as charging recommendation system 106. Assessing the sustainable charging options may be a first step in developing the framework for supporting generating charging recommendations, as described above.

Method 320 begins at 322, where method 320 includes registering charging infrastructure assets of an electric vehicle charging system (e.g., system 100). The charging infrastructure assets may include, for example, solar panel arrays, energy storage devices (e.g., batteries), and/or other components of a charging infrastructure. For example, the charging infrastructure assets may include a depot of a fleet of EVs where the depot includes a solar array. The charging infrastructure assets may be stored in a database, such as infrastructure assets database 226.

At 324, method 320 includes determining, for each charging station of the electric vehicle charging system, whether the charging station has one or more certifications. If at 324 it is determined that one or more charging stations have one or more certifications, method 320 proceeds to 326. At 326, method 320 includes registering the one or more certifications with relevant regulatory authorities.

Alternatively, if at 324 it is determined that no charging stations have certifications, method 320 proceeds to 328. At 328, method 320 includes applying “best available” tools to assign environmental cost values to each charging station. The environmental cost values may rate or rank an environmental cost of charging an EV at the charging station, relative to other charging stations. The “best available” tools may be tools that are recognized by regulatory agencies, such as shared data streams from charging station operators, vehicle telematics data, Argonne National Laboratory's GREET Model, the WattTime API, ISO data, environmental impact inventories and/or other possible sources noted in this publication. The “best available” tools may also include peer-reviewed research on the same or similar equipment (e.g., solar panels, batteries, and chargers, etc.). In addition, assigning the environmental cost values to the energy mix component of environmental impacts of charging stations may include calculating amounts and/or relative percentages of power generated by various energy sources that are supplied at a charging station. In other words, a charging station may supply power from an electric grid (e.g., electric grid 150) with a grid mix, where the grid mix is a mixture of different energy sources that provide energy to the electric grid. The grid mix may include, for example, 20% of electricity supplied by a first energy source (e.g., of the energy sources 170); 30% of electricity supplied by a second energy source; and 50% of electricity supplied by a third energy source. Thus, an EV charging at the charging station will receive electricity from the first energy source, the second energy source, and the third energy source in a 2:3:5 ratio. If the ratio is higher for renewable energy sources, the charging station may be assigned a first, low environmental cost value. If the ratio is lower for renewable energy sources, the charging station may be assigned a second, higher environmental cost value. For example, if the third energy source and one or more of the first and second energy sources are renewable, the charging station may receive a low environmental cost value, indicating that an environmental cost (e.g., an amount of carbon released into the atmosphere during generation) of charging an EV at the charging station is low. Alternatively, if the third energy source and one or more of the first and second energy sources are non-renewable (e.g., from fossil fuels), the charging station may receive a higher environmental cost value, indicating that the environmental cost of charging the EV at the charging station is higher. Thus, by comparing environmental cost values of different charging stations, a driver of the EV may determine how a carbon footprint of the EV may be reduced by selecting one charging station over another.

Determining a grid mix of a charging station may involve steps, including addressing missing data and efficiency losses, adjusting for on-site battery storage and/or generation, and the like. An exemplary method for determining the grid mix of a charging station is described further below in reference to FIG. 7.

At 330, method 320 includes identifying and/or validating features of charging stations to ensure there is no change. In some embodiments, vehicle camera object detection may be used to detect various elements. For example, a charging station may be classified by the charging recommendation system, with a classification indicating that the charging station is registered as having a solar canopy. A plurality of EVs of the electric vehicle charging system may come to the charging station to recharge. When each EV arrives at the charging station, a classification monitoring application installed in the EV may detect, via cameras installed on the EV, whether the solar canopy is installed at the charging station. Results of the classification monitoring may be crowd-sourced and aggregated across the plurality of EVs, for example, using ensemble tree or similar classification methods. Via the classification monitoring application, the charging recommendation system may maintain up-to-date records on available charging infrastructure throughout the electric vehicle charging system.

At 332, method 320 includes determining, for each charging station monitored, whether registered features match the classification (e.g., based on registered information) of the charging station. If the registered features do not match the classification (e.g., for example, if vehicle cameras do not detect the solar canopy), method 320 proceeds to 334. At 334, method 320 includes flagging the charging station for manual review. Alternatively, if at 332 is determined that the registered features match the classification of the charging station, method 320 proceeds to 336.

At 336, method 320 includes designating coefficients for environmental cost calculations based on available information. For example, if it is known that a charging station has an on-site solar panel of a given capacity, life cycle databases and studies may be leveraged to assign a lifecycle impact, while other information may be leveraged to assess electricity production such as data from the charging network provider, weather data, vehicle telematics sunlight intensity data, etc. Method 320 ends.

Referring now to FIG. 3C, an exemplary method 340 is shown for measuring a baseline of environmental costs of EV charging habits, based on information collected from a plurality of EVs and charging stations. Method 340 may be executed by a charging recommendation system for electric vehicles, such as charging recommendation system 106. By generating the baseline of environmental costs, an environmental cost of charging an EV can be measured against a region-or industry-wide standard, which may help foster incremental reductions in a use of non-renewable energy sources as the baseline changes.

Method 340 begins at 342, where method 340 includes obtaining geographic and registration data to identify whether a regulatory baseline exists. In some embodiments, procedures or values for establishing the baseline may be established by a regulatory agency.

At 343, method 340 includes determining whether a baseline procedure has been designated by a relevant regulatory agency. If at 343 it is determined that a baseline procedure has been designated, method 340 proceeds to 344. At 344, method 340 includes following the procedure established by the regulatory agency to establish the baseline. For example, following the procedure established by the regulatory agency may include multiplying a coefficient established by a regulator by an amount of energy consumption indicated by EV charging infrastructure and vehicle data.

Alternatively, if at 343 it is determined that no baseline procedure has been designated by a relevant regulatory agency, a behavioral baseline for a driver's charging habits may be assessed based on collected information prior to active recommendations of sustainable options, whereby method 340 proceeds to 345.

At 345, method 340 includes collecting vehicle and infrastructure data from EV's, charging stations, and other components of the charging recommendation system. The vehicle and infrastructure data may include, for example, SOC information, trip energy consumed, location, time, charge event location and power (kW), charger meta information such as nearby amenities, and the like. In various embodiments, vehicle telemetry data may be leveraged to obtain variables that inform the status quo of charging decisions, habits, and preferences. Common habits surrounding charging locations (home, work, public locations), charging times, charger types, and charging frequency for a given geographic location of vehicle travel may be identified. Given available information on electricity sources and sustainability of one or more charging locations, as well as other charge event information such as time of day, life cycle environmental costs (e.g., g CO2e/kWh, upstream water usage/kWh, etc.) may be computed using most reliable life cycle data on a given route.

At 346, method 340 includes applying one or more learning methods to predict implied user preferences. Applying the one or more learning methods may include applying one or more clustering algorithms to cluster data to reveal different patterns in the data. For example, EV drivers may be clustered based on features like intensity and/or days of vehicle usage; charger type(s), charge location(s), and so on. Different types of high-dimensional statistical methods may be applied. The one or more learning methods may also include applying one or more neural network models. For example, variations of recurrent neural networks (RNN) may be used for time series framing with multi-step forward prediction, or other regression models like extreme gradient boosting (XGBoost) with single step forward prediction. The one or more learning methods may also include recommender systems or recommendation algorithms. Deep learning algorithms on images taken either by a vehicle or other device like a cellular phone may be used to identify station attributes including sustainability, amenities, chargers out of service, etc., which may add feature variables to any recommendation algorithm.

At 348, method 340 includes associating environmental costs to the baseline, including existing events and predicted future charge events. The environmental costs may be associated with the baseline in a manner similar to associating environmental costs to charging stations, as described above and in greater detail below in reference to FIG. 7. The environmental costs associated with the baseline may be expressed as environmental cost values, which may facilitate a direct comparison between various charging options or strategies. For example, a driver seeking to recharge an EV in a sustainable manner may receive a charging recommendation based at least partly on environmental cost values associated with a plurality of candidate charging stations (e.g., that are on or close to a route of the EV). The charging recommendation may indicate which of the candidate charging stations are preferable based on the environmental cost values, and may additionally indicate whether a given candidate charging station is above or below the environmental cost baseline. The driver may select a candidate charging station that is above the baseline.

Referring now to FIG. 3D, an exemplary method 350 is shown for identifying and encouraging drivers to use more sustainable EV charging options, by generating charging recommendations that may be sent to drivers of EVs. Method 340 may be executed by a charging recommendation system for electric vehicles, such as charging recommendation system 106. Lower-CO2 charging behaviors may be identified and encouraged. Given driving, parking, and charging habits, including locations and duration, options may be recommended that may reduce environmental costs.

Method 350 begins at 352, where method 350 includes determining whether a charge event is anticipated for the EV. In some embodiments, a driver of the EV may signal that a charge event is anticipated by transmitting a request for a charging recommendation to the charging recommendation system. In other embodiments, the charge event may be predicted, for example, based on driver habits, battery SOC information or predictions, data from an onboard navigation system (e.g., onboard navigation system 206), or other information.

If it is determined at 352 that a charge event is not anticipated, method 350 proceeds to 353. At 353, method 350 includes waiting until a charge event is anticipated. Alternatively, if it is determined at 352 that a charge event is anticipated, method 350 proceeds to 354.

At 354, method 350 includes establishing a set of candidate charging stations based on selected criteria. The selected criteria may include, for example, distance, travel time, power kW capacity, or other criteria. In some embodiments, the set of criteria may be an initial set of basic criteria that may be used to generate a comprehensive list of candidate charging stations, from which a smaller set of preferred charging options are selected based on other criteria.

At 356, method 350 includes estimating sustainability, cost, and other metrics for each candidate charging station. The sustainability metric may be based on environmental cost values and established as described in reference to FIG. 7 below. A number of vehicle miles traveled (VMT) when deviating from a route to reach candidate (available) charging station may be calculated, which may reflect a sustainability cost (additional battery energy expended, etc.) and a time cost. Battery degradation and efficiency loss may be taken into account, and an environmental cost of energy charged given station attributes may be considered. For example, the environmental cost of charging an EV at a charging station may be reduced if the charging station has an on-site solar setup, RECs, or if an energy mix demanded from the grid favors renewable sources based on a time of day or season, or other factors.

An alternative embodiment may leverage methodologies disclosed herein to recommend refueling options to vehicles that are not 100% battery electric such that environmental impacts are minimized. For example, if gas station (A) offers corn-based ethanol E85 and gas station (B) offers switchgrass cellulosic or algae based ethanol E85, while both offer gasoline, there are four refueling choices to consider (two E85 pathways and two gasoline options). For diesel vehicles, a route may include fossil diesel, a 20% (B20) biodiesel blend, and renewable diesel fuel across different stations. For fuels like hydrogen, natural gas, propane, dimethyl ether, etc., there may be a wide range of outcomes depending on use of a fast vs. slow-fill stations, compression or chilling requirements, any certification of steps to prevent methane leakage, and fuel pathway. For example, hydrogen with 33% renewable mix and a majority from fossil natural gas may be compared with hydrogen generated at a dispensing site from food waste biogas. Finally, across fuel types, infrastructure may still use electricity from the grid, have on-site solar panels (for example, on the canopy of a fuel station), and other attributes that impact environmental impacts.

At 358, method 350 includes estimating preference metrics. The preference metrics may be used to filter the list of candidate charging stations and provide recommendations. Driver preferences may be accounted for, such as for stopping locations and charging times. In some embodiments, objectives like fitness goals may be gamified, where additional walking or short bicycle rides between a charging station and a desirable location may be incorporated into a charging strategy, which may be beneficial to the driver and expand a radius of charging station options. For example, a charging recommendation may suggest parking at a certain location and plugging the EV in for a low-emissions charge with an extra ten minutes spent on an e-cargo bicycle delivery, or parking at a corporate yard that includes on-site solar and adding a ten minute walk, or stopping before work at the gym, which has a Level 2 charger and a lower-carbon profile than plugging in after work. Further, added flexibility with respect to including micro-mobility or walking or high-throughput transit connection to expand the radius of candidate charging stations, could be applied to an autonomous (AV) electric vehicle ride-sharing services. Nearby amenities may be referenced for given user preferences and charging time. For example, a driver may select a charging station near coffee shops, restaurants, supermarkets, or other places of interest if a charging time is long.

Fleet-wide preferences may also be identified and incorporated into a charging recommendation or charging recommendation strategy. If a most recommended (e.g., sustainable) charging station is near a destination, a remaining distance between the charging station and the destination might be covered via micro-mobility for last-mile deliveries, while the vehicle charges. Fleet vehicle schedules may be ingested to determine when down time may be expected, such as at a job site or during meals. Charging stations may be recommended for specific times that might reflect the most sustainable charging option for a customer, especially one with a known route.

Effects on vehicle components may also be accounted for. For example, Level 2 charging opportunities may be recommended where daily patterns suggest typical extended stop locations, or location types in lieu of DC Fast. In one embodiment, environmental cost values may be transformed into one metric, since GHG g CO2e is not directly comparable with water usage or land use. Alternatively, various costs in a recommendation algorithm could be weighted similarly. For example, in one embodiment, a metric for sustainability may be displayed against other familiar metrics to the owner, such as increased time to a destination or in a schedule, or an increased or decreased cost of a relevant charging station, which may enable a driver/owner to make informed decisions more easily.

At 360, method 350 includes accounting for bidirectional power opportunities where applicable. For example, more energy from a charge event than may be used by the vehicle may be stored in a battery, with intent to dispense the energy at a later time, if a generation of energy from renewables is high (especially in cases of active renewable energy curtailment due to oversupply). For example, a first charging station with a solar canopy that stores excess energy retrieved from the grid in an on-site battery may be assigned a lower environmental cost than a second charging station that does not store excess energy (e.g., when the excess energy is generated in a low-carbon scenario or time).

At 362, method 300 includes determining whether the EV participates in any monetary schemes. For example, the EV may participate in fleet low carbon credits, public carbon taxes, rewards points, and/or other incentive programs. If at 362 it is determined that the EV participates in one or more monetary schemes, method 350 proceeds to 364. At 364, method 350 includes sharing rewards from the one or more monetary schemes with drivers who make the most sustainable decisions. By sharing the rewards with the drivers, greater incentives may be provided for charging EVs at charging stations with low environmental cost ratings.

If at 362 it is determined that the EV does not participate in any monetary schemes, method 350 proceeds to 366. At 366, method 350 includes ranking a plurality of EV charging options that are recommended to the driver to minimize environmental cost of charging the EV while achieving other driver preferences. The plurality of EV charging options may be selected from the list of candidate charging stations described above, after the considerations and adjustments described in steps 356-364 have been made. In various embodiments, the ranking may be used to order the EV charging options in the charging recommendation sent to the EV. Ranking of the charging options is described in greater detail below in reference to FIG. 4B. Method 350 ends.

Referring now to FIG. 3E, an exemplary method 370 is shown for identifying and encouraging charging stations to supply more sustainable EV charging. Method 370 may be executed by a charging recommendation system for electric vehicles, such as charging recommendation system 106.

Method 370 begins at 372, where method 370 includes determining whether a charging station is used by a fleet of EVs. If the charging station is a fleet charging station, method 370 proceeds to 374. At 374, method 370 includes quantifying opportunities to reduce environmental costs of EV charging. For fleets, where charging may be a mix of depot charging, employee home charging, and public charging, recommendations for reducing environmental costs might be made to the fleet operator. This may also be relevant if the fleet opens a charging depot to the public during low-use days and times, whereby the charging depot serves a dual purpose as a public charging infrastructure provider. The

Referring briefly to FIG. 6, a charging strategy bar chart 600 shows an example charging strategy recommendation for a fleet housed at a depot, where the depot may supply energy from an electric grid as well as generate and/or store energy on-site (e.g., via solar arrays, batteries, etc.). For this example, is is assumed that CO2 is an environmental impact metric the fleet wants to prioritize. An amount of CO₂ released into the atmosphere as a result of generating electricity from various different charging options offered at the depot is shown on a vertical axis of bar chart 600, and the different charging options are plotted along a horizontal axis of bar chart 600. A first bar 602 represents a first charging option for charging vehicles of the fleet; a second bar 604 represents a second charging option; a third bar 606 represents a third charging option; and a fourth bar 608 represents a fourth charging option. A dashed line 610 may indicate a sustainability target (e.g., target amount of CO₂ released during generation). The sustainability target may be imposed by a fleet manager, or by a city or region where the fleet is located, or by a different regulatory authority. Bar chart 600 showing impacts of various scenarios relative to an original baseline indicated by first bar 602 and target indicated by dashed line 610 may be generated from data collected from the fleet and using the metrics described above, and below in reference to FIG. 7.

For example, the first charging option represented by first bar 602 may indicate a baseline amount of CO₂ released when charging an EV of the fleet at a public charging station under a sustainable charging framework such as described herein. The second charging option represented by second bar 604 may indicate an amount of CO₂ released when charging EVs of the fleet at the depot, where an environmental cost of charging the EVs at the depot is lower than charging the EVs at public charging stations, due to the depot purchasing RECs. The third charging option represented by third bar 606 may indicate an amount of CO₂ released when charging EVs of the fleet at the depot, using solar chargers of the depot rather than energy sources available via the grid. The fourth charging option represented by fourth bar 608 may indicate an amount of CO₂ released when bi-directional EVs of the fleet are leveraged to store clean (e.g., from a renewable source) power generated during a first, low-carbon time, to be used to charge other EVs during high grid CO₂ times.

Using the charging strategy recommendation shown in FIG. 6, a fleet manager may determine, based on a relative cost of the different charging options shown, which option(s) to choose. The options include fleet depot EV infrastructure amenities, as well as charging strategies, that may be used to achieve sustainability targets for the fleet as a whole.

Returning to FIG. 3E, if the charging station is not a fleet charging station, method 370 proceeds to 376. At 376, method 370 includes sharing recommendation data and/or an Application Programming Interface (API) of the charging recommendation system with EV charging network providers. For example, via the API, users of individual EVs may be sent recommendations for charging options and strategies, as described elsewhere herein. In some embodiments, the strategy recommendations may be similar to or may share a similar visual design with bar chart 600 of FIG. 6.

For public charging stations, if drivers are encouraged to use more sustainable EV charging options as described above in reference to FIG. 3D, a market-based mechanism may be provided that incentivizes EV infrastructure providers to offer sustainable charging solutions. Less sustainable locations are less likely to be recommended. On the supply side, data and sustainability components of the recommendation algorithm may be shared with EV charging station operators to help them understand the effect of adding sustainability measures, and consequently act to make an offering more sustainable. In addition, vehicle and driver preference data could be leveraged to support siting of sustainable charging options.

Referring now to FIG. 3F, an exemplary method 380 is shown for measuring an effect of the charging recommendations, as compared with the baseline calculated as described above in reference to method 340 of FIG. 3C. Measuring the effect of the charging recommendations may facilitate making improvements to the charging recommendation system, such as adding incentives for drivers to seek more sustainable charging options. Method 380 may be executed by a charging recommendation system for electric vehicles, such as charging recommendation system 106.

Method 380 begins at 382, where method 380 includes measuring environmental costs with respect to CO₂ at each charge event. In other words, when an EV recharges a battery at a charging station, relative contributions to the energy received via the grid from various energy sources may be analyzed and calculated to quantify the environmental cost of the charge event, as described below in reference to FIG. 7.

At 384, method 380 includes determining whether a routine of the driver of an EV is predictable. If at 384 it is determined that the routine is predictable, method 380 proceeds to 386. At 386, method 380 includes comparing an outcome of a charging station recommendation with what would be expected from a baseline outcome. One simple method may be to identify users with a same daily routine (home location, trip types, etc.), and then evaluate a sustainability of their charging choices before and after implementation of the recommendation system. An alternative embodiment might measure effects of specific recommendations. To control for self-selection bias, a sample used may include users who opt in to recommendations. Presumably, users including sustainability in their charging parameters might otherwise exhibit more sustainable behaviors based on their own research.

Alternatively, if at 384 it is determined that the routine is not predictable, method 380 proceeds to 388. At 388, method 300 includes calculating a baseline for estimating environmental impact reduction based on alternative charge event outcomes. The baseline may be the charging alternative ranked highest absent environmental impact information, or it may be the average of the alternative charging scenarios, or some other baseline preferred by the customer or an accreditation or regulating agency.

At 390, method 380 includes measuring habit formation, based on decisions to use charging recommendation versus a baseline after initial occurrences of a recommendation. For example, driver behaviors may be examined to determine whether habits oriented around sustainability have been formed. When a recommendation is made, a first portion of drivers may stick to old patterns of charging strategies, while a second portion of drivers may adopt new habits based on the recommendations. The first portion may be compared to the second portion, to determine a habit formation rating of the recommendation. The habit formation rating may be used to assess an effectiveness of the charging recommendations.

Referring now to FIG. 4A, an exemplary method 400 is shown for requesting and receiving a charging recommendation at a vehicle (e.g., an EV) from a charging recommendation system, such as charging recommendation system 106 of FIGS. 1 and 2. In some embodiments, method 400 may be executed by a controller of the vehicle (e.g., controller 105), in response to a user input of a driver of the vehicle. For example, the driver may request a charging recommendation by selecting a control on a dashboard UI of a charging recommendation application installed in the vehicle (e.g., charging recommendation UI 209), or via a voice command receivable by the charging recommendation application. In other embodiments, method 400 may be executed automatically by the controller in response to a predicted future charge event. For example, a prediction module of the controller may monitor vehicle data such as battery charge, SOC, historical route information, time of day, and others, and based on the vehicle data, predict when the driver will wish to recharge the vehicle. In some embodiments, the prediction module may include one or more machine learning and/or other statistical models.

Method 400 begins at 402, where method 400 includes measuring/estimating vehicle operating conditions. Measuring/estimating the vehicle operating conditions may include determining an SOC of the battery, estimating a current consumption of stored energy based on a route of the vehicle and/or a driving style of the driver, and/or other operating conditions, as well as determining whether the vehicle is being propelled by the battery or whether the vehicle is stopped. For example, the vehicle may be stopped at a battery charging station.

At 404, method 400 includes determining whether a battery charging recommendation has been requested. In some embodiments, the battery charging recommendation may be requested by the driver. For example, the driver may monitor a charge of the battery via a display element on a dashboard of the vehicle, and the driver may request the battery charging recommendation when the charge decreases below a threshold level. The threshold level may change depending on circumstances. For example, in a first set of circumstances, the driver may be operating the vehicle in an environment or on a route where a number of available charging stations is low. As a result of the number charging stations being low, the driver may request the battery charging recommendation when the charge of the battery decreases to a first threshold level, where the first threshold level is sufficiently high that the driver has an opportunity to determine where to recharge the vehicle prior to depletion of the charge of the battery. In a second set of circumstances, the driver may be operating the vehicle in an environment where charging stations are plentiful and easy to find and access. As a result of the charging stations being plentiful and easy to find and access, the driver may allow the charge of the battery to decrease to a second, lower threshold level before requesting the charging recommendation.

Alternatively, in a third set of circumstances, the driver may wish to plan where to recharge the vehicle well in advance, for example, when planning a trip or to adhere to a schedule. In the third set of circumstances, the driver may request the battery charging recommendation prior to the charge of the battery achieving a threshold charge and/or without considering a level of the charge.

In other embodiments, the battery charging recommendation may be requested automatically by the controller based on a predicted future charge event. For example, the controller may include a charging prediction module (e.g., charge event prediction module 218) including one or more machine learning models, where the one or more machine learning modules may be trained to predict when the driver may wish to receive a charging recommendation. The controller and/or the one or more machine learning modules may predict the future charge event based on one or more factors, including a charge of the battery; historical driving data of the driver; a route of the vehicle; a schedule of the driver; and/or other factors.

If at 404 it is determined that a battery charging recommendation has not been requested, method 400 proceeds to 406. At 406, method 400 includes maintaining operating conditions of the vehicle until a battery charging recommendation has been requested, and method 400 ends. Alternatively, if at 404 it is determined that a battery charging recommendation has been requested, method 400 proceeds to 408.

At 408, method 400 includes establishing a secure anonymous connection with the charging recommendation system. The secure anonymous connection may be created by a communication module (e.g., communication module 208) of the vehicle, based on instructions provided by the controller.

At 410, method 400 includes classifying and ranking the battery charging parameters based on a relevancy of the battery charging parameters. As described above in relation to FIG. 2, the battery charging parameters may be ranked by the charging parameter ranking module (e.g., charging parameter ranking module 220) of the controller.

In some embodiments, the battery charging parameters may be classified into various classes, where a class of a battery charging parameter may indicate a relevance of the battery charging parameter under a specific scenario. For example, a first class may include battery charging parameters relevant to an urgent demand to recharge the vehicle as soon as possible (e.g., battery charge and route information); a second class may include battery charging parameters relevant to a particular incentive structure for recharging the vehicle sustainably (e.g., incentive data, historical driver data); a third class may include battery charging parameters relevant to a use of the vehicle (e.g., charging frequency data, battery size data); and so on. The battery charging parameters may be shared between different classes, or exclusive to different classes. In other embodiments, each battery charging parameter may be assigned a rank based on a relevance of the battery charging parameter to a current or future scenario of the vehicle. As described above, in a first scenario, a first set of battery charging parameters may be assigned a high rank, and other battery charging parameters may be assigned lower ranks. In a second scenario, a second, different set of battery charging parameters may be assigned a high rank, and remaining battery charging parameters may be assigned lower ranks.

In various embodiments, the classification and/or ranking of the battery charging parameters may be performed by a machine learning (ML) model trained to learn a relative importance of each of the battery charging parameters to the current or future scenario. For example, a neural network model may be trained on historical charge event data collected at the vehicle. If a previous charging recommendation was followed by the driver in a certain scenario, the battery charging parameters used to generate the previous charging recommendation may be used as ground truth data to train the ML model. In some embodiments, the ML model may rely on a recurrent neural network. The classification and/or ranking of the battery charging parameters may also be performed by one or more high-dimensional statistical models or techniques. At 412, method 400 includes selecting a portion of the battery charging parameters to transmit to the charging recommendation system via a selection algorithm. In some embodiments, the selected portion may be selected by the charging parameter ranking module. For example, the algorithm of the charging parameter ranking module may set a threshold rank, and battery charging parameters having a ranking above the threshold rank may be included in the selected portion, while battery charging parameters having a ranking below the threshold rank may not be included in the selected portion. In other embodiments, the charging parameter ranking module may establish various rankings for different battery charging parameters, and the controller may determine which battery charging parameters are included in the selected portion based on the rankings. For example, the controller may establish the threshold, or may establish which battery charging parameters are included in the selected portion by applying one or more rules of a rules-based system installed in a memory of the controller.

At 414, method 400 includes transmitting the selected portion of the battery charging parameters to the charging recommendation system via the secure anonymous connection. In other words, the controller may receive the selected portion of the battery charging parameters from the charging parameter ranking module of the controller, and the controller may transmit the selected portion of the battery charging parameters to the charging recommendation system via the communication module over the secure anonymous connection.

At 416, method 400 includes receiving a charging recommendation for a future battery charge event of the vehicle from the charging recommendation system via the secure anonymous connection. The charging recommendation may be received by the communication module of the vehicle and transmitted to the controller.

At 418, method 400 includes displaying the charging recommendation in the display of the vehicle and/or storing the charging recommendation in the memory of the controller. For example, the controller may display the charging recommendation on a touchscreen of a dashboard of the vehicle (e.g., charging recommendation UI 209). The charging recommendation may include a plurality of options, where each option of the plurality of options includes a charging station at which the vehicle may recharge. In some embodiments, the plurality of options may be listed or displayed as an ordered series, where a position of each option in the ordered series of options is based on a ranking of the option. The ranking may be assigned, for example, by a recommendation engine (e.g., recommendation engine 227) of the recommendation system. For example, a charging recommendation may include a first option including a first charging station, a second option including a second charging station, and a third option including a third charging station. The first option may be a most recommended option, where the first charging station has a highest ranking; the second option may be a less recommended option, where the second charging station has a lower ranking than the first charging station; and the third option may be an even less recommended option, where the third charging station has a lower ranking than the first charging station and the second charging station. As described in greater detail below in reference to FIG. 4B, the rankings may be based on reducing a carbon footprint of the vehicle, while taking into consideration other priorities of the vehicle and/or driver.

When the plurality of options of the charging recommendation are displayed on the touchscreen, a driver of the vehicle may select a desired option of the plurality of options. The driver may select (e.g., accept) the most recommended option, or a less recommended option. In some embodiments, the driver may request additional information about one or more charging stations. For example, the driver may select an option via a first control of the UI, and select to view the additional information via a second control of the UI. The additional information may include, for example, more detailed data regarding sources of the electricity supplied at the selected charging station (e.g., energy sources 170).

FIG. 4B shows an exemplary method 450 for generating a charging recommendation for an EV at a charging recommendation system, in response to a request from the EV, which may be sent via a method such as method 400 above. Method 450 may be executed by a processor (e.g., processor 222) of the charging recommendation system. One or more steps of method 450 may be executed by a charging recommendation engine, such as charging recommendation engine 227.

Method 450 starts at 452, where method 450 includes establishing a secure anonymous connection with the EV. In various embodiments, the secure anonymous connection may be requested by a communication module of the EV (e.g., communication module 208).

At 454, method 400 includes determining whether the secure anonymous connection with the EV has been established. If at 454 it is determined that the secure anonymous connection has not been established, method 450 proceeds to 456. At 456, method 450 includes waiting until the secure anonymous connection with the EV has been established, and method 450 ends. Alternatively, if at 454 it is determined that the secure anonymous connection has been established, method 450 proceeds to 458.

At 458, method 450 includes receiving select classified and ranked battery charging parameters via the secure anonymous connection. The battery charging parameters may be classified and ranked by a charging parameter ranking module of the EV, as described above in reference to method 400.

At 460, method 450 includes generating a charging recommendation for the EV, based on the select battery charging parameters. The charging recommendation may include an ordered list of charging options, where a driver of the EV may select one charging option of the ordered list of charging options. The order of the charging options may be based on a ranking of the charging options by the recommendation engine. The ranking may be at least partially based on the rankings of the battery charging parameters received from the EV. Additionally, the ranking of the charging options may be based at least partially on an environmental cost value assigned to a charging station included in each charging option, as described below in reference to FIG. 7.

Each charging option may include a charging station that the EV may navigate to for recharging. For example, a first charging option may recommend that the driver navigate the EV to a first charging station, and a second charging option may recommend that the driver navigate the EV to a second charging station, where the second charging station is different from the first charging station. The charging option may also include a recommended time of charging. For example, the first charging option may recommend that the driver navigate the EV to a first charging station at a first time, and a third charging option may recommend that the driver navigate the EV to the first charging station at a second time, where the second time is different from the first time. For example, the first charging station may supply electricity generated from a solar canopy (e.g., solar array 154) during daylight hours, and may supply electricity transferred from an electric grid (e.g., electric grid 150) at night. Thus, the charging recommendation may recommend an option for charging the EV at the first charging station during the day, to receive sustainably produced energy, but may not recommend an option for charging the EV at the first charging station at night.

The charging recommendation may be generated in various ways. In some embodiments, the charging recommendation may be generated by one or more algorithms of the recommendation engine, where the one or more algorithms apply one or more rules to the battery charging parameters to output the charging options. A series of algorithms may be applied in a series of steps of a rules-based system, where the rules are established by human experts. The rules may be based on an analysis of historical data.

For example, a first algorithm may determine an urgency of recharging the EV, based on a first portion of the battery charging parameters (e.g., battery charge, availability of charging stations, schedule, etc.). A rule may state that if the battery charge is below a threshold level, the charging recommendation may include a charging station that is closest to the EV as a first (e.g., top ranked and most preferable) charging option. A second algorithm may determine a sensitivity of the driver to price differences at different charging stations. For example, the second algorithm may apply rules to historical purchasing data to determine a desired price range at which the driver wishes to purchase electricity for the EV. The desired price may be established by a fleet manager of the EV. Some or all of the historical purchasing data may be captured in one or more battery charging parameters (e.g., historical data of the EV), and some or all of the historical purchasing data may be retrieved from a different source, such as recommendation database 225 of the charging recommendation system and/or external databases 130 of FIG. 1. Additional algorithms and rules may be applied to further refine or reorder the charging options included in the charging recommendation.

In other embodiments, ranked charging options may be generated by an ML model, such as a neural network. For example, the neural network may receive the battery charging parameters and one or more charging options as input, and the neural network may be trained to output a score of the charging option. During a training stage, historical data received from the EV and/or historical data stored in one or more databases of the charging recommendation system and/or one or more external databases accessed by the charging recommendation system may be used as ground truth data. During a subsequent deployment of a trained ML model, as one example, in a first step, a rules-based system (as described above) may generate a list of candidate charging stations from the battery charging parameters. In a second step, the candidate charging stations may be inputted into the neural network along with the battery charging parameters, and the trained neural network may generate the score for each of the candidate charging stations. In a third step, a different algorithm and/or rules-based system may determine which and/or how many of the candidate charging stations may be included as options in the charging recommendation, based on the scores of each candidate charging station. The charging options may be ranked (e.g., ordered) based at least partially on the score. Because the score is generated from inputs including battery charging parameters that capture diverse driver preferences (e.g., cost, speed and time of charging, etc.), in contrast to other approaches to generating and ranking charging options, the ranking of the charging options may not be based entirely on prioritizing a sustainability of the electricity used to recharge the EV. By taking into account the diverse driver preferences, an adoption rate of the charging recommendations may be increased, which may lead to a more widespread use of renewable energy sources.

In still other embodiments, charging options may be ranked or classified using statistical methods. For example, for each candidate charging option, the battery charging parameters and parameters representing the candidate charging option may be included in a data vector. The data vectors may then be clustered or compared, using various statistical techniques, to determine groupings or patterns that may be used to classify alternatives and prioritize the candidate charging options. The statistical methods may include, for example, k-means clustering, nearest neighbor clustering, and self-organizing maps.

In addition, machine learning methods may be leveraged to support assessment of the impact of charging recommendations, which may complement other results like scenario analysis and support outcomes like sustainability reporting and regulatory credits. For example, difference in difference regression may be used.

It should be appreciated that the examples provided above are for illustrative purposes, and different types and/or combinations of rules-based systems, ML models, and/or statistical methods may be used to classify or rank various charging options without departing from the scope of this disclosure.

At 462, method 450 includes sending the charging recommendation to the EV, via the secure anonymous connection, and method 450 ends.

Referring now to FIG. 7, an exemplary method 700 is shown for calculating a grid mix of a charging station, where the grid mix is a mixture of different energy sources providing energy to an electric grid to which the charging station is electrically coupled. Method 700 may be executed by a processor of a charging recommendation system (e.g., processor 222 of charging recommendation system 106), within an electric vehicle charging system such as electric vehicle charging system 100 of FIG. 1. By calculating the grid mix, an environmental cost value may be assigned to a charge event, that indicates an environmental cost of charging an EV at a charging station at a given time, as described above in reference to FIG. 3B.

Method 700 begins at 702, where method 700 includes determining an amount of electrical energy (kWh) received at the EV from the charging station during an EV charge event. In various embodiments, the amount of electrical energy transferred from the charging station may be displayed on a display screen of the charging station, in billing messages transmitted to a driver of the EV, and in an account history. In one embodiment, the recommendation may be a part of a manufacturer-based charging network (for example, a commercial charging network may not rely on drivers creating separate accounts with each station provider). In another embodiment, data sharing with a charging network or third party charging recommendation may occur with user consent and restrictions on data usage (for example, not permitting sale of the data for any purpose other than performing methods and providing results as described herein). To determine an amount of electricity received by the EV, vehicle data may be recorded. Current and voltage data may be preferred to SOC data, when available, because a change in SOC may not provide an accurate enough estimate of electricity consumed due to open circuit voltage and SOC having a non-linear relationship.

At 704, determining the amount of electrical energy (kWh) received at the EV from the charging station during an EV charge event may include handling missing data. For various reasons, during some charge events data either from the charging station and/or the EV may be missing. One reason is because not all public charging stations may be “smart” with respect to an Internet connection, and may not report electricity received to the driver. Further, data collection at the EV may be disrupted. For example, an over-the-air (OTA) update received during the charge event may disrupt the data collection.

Missing data may be handled leveraging one or more of: (1) redundant signal information that may exist; (2) redundant or relevant parameters transmitted by charging infrastructure and the vehicle (e.g., if vehicle data transmission is missing, then information available from the infrastructure may fill gaps); (3) assumption or default values based on last-available data; (4) local store of the data and (5) machine learning models.

As an example of (1), electric vehicle data may include controller area network (CAN) signals indicating energy consumption, such as instantaneous current and voltage and state of charge (SOC). In addition, the vehicle may compute relevant diagnostic messages, including those messages specified by SAE J1979 standard such as Mode 09 message 0×1 C “Total grid energy into the battery (Lifetime).” If the vehicle does not transmit expected data during the charge event, a diagnostic message on the lifetime signal might be leveraged to fill in missing information about the charge event.

As another example of (1), if information on the charging station's infrastructure is missing or outdated, camera data (for example from the vehicle) may be used to support validation. Examples of objects to classify and quantify include on-site chargers, solar panels, and battery storage systems.

As an example of (4), suppose charge event energy input is not made available by charging infrastructure. Using vehicle data on ambient conditions during the charge event, energy input into the battery, efficiency losses can be predicted. Such a prediction may include at the charge event level. A higher resolution is also possible if the data are available, for example given input power at a given point, other vehicle sensor information including ambient condition measurements, what are the expected efficiency losses. Such a higher resolution prediction of losses over the course of the charge event may be summed to estimate an event-level total loss.

At 706, determining the amount of electrical energy (kWh) received at the EV from the charging station during an EV charge event may include adjusting for efficiency losses between a charging station output and the EV. In some cases, vehicle data may show how much electricity was charged to a battery of the EV (e.g., energy storage device 204) at any point during the charge event, enabling assignment of environmental costs based on time. Since the electricity charged to the battery at a given time is likely less than the electricity provided by the charger (e.g., due to the efficiency losses), a charge event-level efficiency loss may first be determined using equation 1 below:

$$Charge event efficiency loss = \frac{charge event total energy recorded by vehicle ( kWh )}{charge event total energy recorded by charging station ( kWh )} \qquad ( 1 )$$

The resulting charge event-level efficiency loss may then be multiplied by an amount of electrical energy recorded as received by the vehicle, in accordance with equation 2:

Adjusted energy chargedₜ

=(Energy recorded by vehicle)ₜ×(Charge event efficiency loss) (2)

Because literature shows that efficiency losses are lower at higher charging speeds, a result of this approach may be a slight over-weighting of efficiency losses at high charging speed portions of charge events, and a slight under-weighting at lower charging speed portions. For example, efficiency losses may become underweighted when the SOC has passed 80%, and charging speed is slowed down toward Level 2 speeds (e.g., 6 or 7 kW). In other embodiments where sufficient data is available, an ML model may be trained to estimate an amount of energy lost due to charge event efficiency losses.

At 708, method 700 includes calculating an environmental impact/kWh value associated with the charge event. In some embodiments, one or more of various publically available models may be used to calculate the environmental impact/kWh value. For example, one model is Argonne's GREET Model, which has been used to calculate well-to-pump lifecycle environmental costs of various electricity sources in the California grid mix assuming calendar year 2022. An output of the one or more models may be complemented by studies in literature, for example, to assign environmental costs to off-grid solar charge events. Supply sources may also be matched to ISO supply sources, or more granular information on supply mix and marginal power generation contingencies (e.g., if additional energy is demanded, what generation sources will be switched on and at what thresholds) if data are available.

Alternatively, at 710, method 700 may include assigning an emission rate/kWh to the charge event based on one or more of various applicable charge event scenarios. At 712, the emission rate/kWh may be assigned to the charge event under a grid electricity scenario, where the EV receives electricity from an electric grid (e.g., electric grid 150). In some embodiments, the emission rate/kWh may be assigned based on publicly available grid information. For example, CA ISO grid information includes supply data by power source and calculated emissions rates for each five-minute interval. This portion of method 700 focuses on the micro-level effect (one vehicle's decision) as opposed to macro-level effect (the totality of vehicles in each grid making a decision on when to charge). Thus, the assumption is the marginal effect of an individual EV charge will not demand enough electricity to turn on an additional power plant, so the ISO 5-minute interval value suffices. Charge event environmental costs such as carbon intensity (CI) may be assigned by weighting the five-minute CI values with energy added during each five-minute interval t, as follows:

$$Charge CI ( \frac{gCo 2 e}{kWh} ) = \frac{\begin{matrix}\sum ( Charge CI ( \frac{gCo 2 e}{kWh} ) \times \\ {Charge Energy ( kWh ) )}_{t}\end{matrix}}{\sum {( Charge Energy ( kWh ) )}_{t}} \qquad ( 3 )$$

At 714, method 700 may include assigning an emission rate/kWh to a charge event in a scenario where RECs are purchased by the charging station. This may include, for example, public charging station RECs (e.g., EVgo, Electrify America); private home charging RECs (e.g., SMUD Green Energy program); car OEM home charging RECs (e.g., Ford Sustainable Charging); and/or others. An objective in this scenario may be to capture a sustainability benefit to RECs while acknowledging a time-dependent effect of charging on CI. In some embodiments, a company that has purchased an REC may share details of the REC (e.g., time of day and renewable energy type), while in other embodiments, no data may be available.

CI during an EV charge event with RECs may include the grid average CI, because the charge event may be consuming energy from the grid at the time of charging the EV. In addition, an REC may be associated with a potentially non-zero CI, even if substantially lower than from fossil energy sources. On the other hand, the REC may be assumed to offset a demand for production of an equivalent amount of energy at the time the REC was generated. In one embodiment, the environmental footprint for RECs may be adjusted using equation 4 below:

$$REC Adj Charge CI {( \frac{gCo 2 e}{kWh} )}_{t} = Grid Avg CI {( \frac{gCo 2 e}{kWh} )}_{t} + \{ REC Adj Charge CI {( \frac{gCo 2 e}{kWh} )}_{tad j} - Grid Avg CI {( \frac{gCo 2 e}{kWh} )}_{tad j} \} \qquad ( 4 )$$

where tadj corresponds to an estimated time the REC is assumed to have been generated. Because more renewable energy is produced at certain times of day, and more of some renewable energy sources are produced than others, one approach is to make a random selection of tadj and the associated renewable energy source from the day of the charge event.

Using this formulation, it is possible to achieve a negative CI by charging at the lowest-possible CI times, if RECs were purchased at average CI times. As an example, an average renewable energy emissions rate may be 50 g CO2e/kWh based on historical data. Cases of RECs overlapping can increase the potential for a negative CI.

At 716, method 700 includes adjusting the charge CI of the charge event for an on-site battery energy storage system used at the charging station. Battery energy storage has a greenhouse gas (GHG) cost (e.g., due to battery life cycle processes such as manufacturing, use phase, and end of life) and a GHG benefit (use of electricity stored from lower-carbon times and any on-site solar production), both of which depend on an implementation at the site (e.g., solar array size, battery size, etc.). In one example, an environmental cost of grid-tie solar is set to 50 g CO2e/kWh, based on historical/statistical data. In determining a battery energy storage benefit, to test boundary conditions, one adjustment may be to take a lowest published ISO grid CI for the day of the charge event and set that value as the CI:

$$BESS CI ( \frac{gCo 2 e}{kWh} ) {=}_{day}^{min} \{ CA ISO Grid CI \} \qquad ( 5 )$$

At 718, method 700 includes adjusting the charge CI for the charge event for an on-site grid-tie solar setup of the charging station. In addition to supplying electricity for immediate charging, grid-tie solar energy may mitigate a demand for grid energy, and may send energy back to the grid or to an energy storage system for use at a later time. Additionally, when used for immediate EV charging, the electricity may be consumed by the vehicle or captured in a vehicle battery for grid services. An efficiency loss for each pathway may be different. In some embodiments, information with respect to handling specific pathways, estimating solar installation size and on-site charger demand, and factoring in time of day for solar energy generation may be provided by a charging station operator with precise measurement. In some examples, an equation such as equation 6 below may be used, which assumes that the energy is used directly for vehicle use, and that an on-site solar array may cover a heuristic value of 20% of the energy charged at that location:

$$On Site Grid Tie Solar CI ( \frac{gCo 2 e}{kWh} ) = 0.2 \times \{ Solar CI ( \frac{gCo 2 e}{kWh} ) + 0.8 \times \{ No - Solar CI ( \frac{gCo 2 e}{kWh} ) \} \qquad ( 6 )$$

where No-Solar CI corresponds to an amount of energy consumed at the charging station that is not covered by solar, calculated at steps 712-716 above. For example, the electricity may be sourced from the grid, covered by RECs, or include battery energy storage.

At 720, method 700 includes adjusting the charge CI for the charge event for on-site, off-grid solar setups. In some embodiments, the off-grid solar CI may be assigned based on historical data. For example, in one embodiment based on Northern California public charging stations, with setup options including 20, 22, 32, and 43 kWh battery sizes and 21×10.6 foot solar array, an off-grid solar CI may be assumed to be 88 g CO2e.

$$Off Grid Solar CI = ( \frac{gCo 2 e}{kWh} ) = 88 ( \frac{gCo 2 e}{kWh} ) \qquad ( 7 )$$

At 722, method 700 includes updating the charge CI for the charge event based on the adjustments described above. The charge CI may be updated in accordance with equation 8 below, and method 700 ends:

$$( 8 )$$

$$Battery CI {( \frac{gCo 2 e}{kWh} )}_{t} = \frac{\begin{matrix}Battery CI {( \frac{gCo 2 e}{kWh} )}_{t - 1} \times Battery Energy {kWh}_{t - 1} + \\ Charge CI ( \frac{gCo 2 e}{kWh} ) \times Charge Energy ( kWh )\end{matrix}}{Battery Energy {kWh}_{t - 1} + Charge Energy ( kWh )}$$

Thus, systems and methods are described herein to facilitate the generation of customized charging recommendations for EVs, where the customized charging recommendations are generated at a cloud-based charging recommendation system based on a plurality of battery charging parameters transmitted from an EV. The battery charging parameters may be selected by a controller of the EV based on various priorities of an owner or driver of the EV, including a desire to reduce a carbon footprint of the EV; incentives such as RECs for reducing the carbon footprint of the EV; a sensitivity to price; a desired charging time or time taken to recharge the EV; and others. The battery charging parameters may be sent via a secure anonymous connection, to protect a privacy of driver and/or vehicle data. The battery charging parameters may be selected and/or ranked by the controller prior to being transmitted to the cloud-based server. The charging recommendation generated from the selected and/or ranked battery charging parameters may include preferred options for charging stations and/or charging times, where the preferred options may reduce a carbon footprint of the EV by directing the EV to charging options offering energy generated from renewable sources rather than non-renewable sources. To generate the charging recommendation, environmental cost values may be calculated and assigned to potential charge events at various charging stations. By following the charging recommendation, the driver may lower the carbon footprint of the EV. Further, by providing a mechanism for drivers to select charging stations that offer a greater percentage of energy from renewable sources, market incentives may be created that result in charging stations reducing a reliance on fossil fuels. For example, a charging station may attract more customers by including a solar array and/or battery storage at the charging station. An overall result may be that a carbon footprint of a population of EVs may be reduced.

While other attempts have been made to offer charging recommendations, for example, based on battery charge data and route information, by generating the charging recommendations from a plurality of battery charging parameters of the EV selected by the controller, a higher degree of customization may be achieved. The higher degree of customization may take into account a wider variety of interests and priorities of the driver than other recommendation systems, which may lead to a higher adoption rate of the charging recommendations. As a result of the higher adoption rate, a virtuous cycle may be created whereby charging stations increasingly compete to provide more sustainable options than their competitors, thereby increasing an amount of data collected and increasing a quality of the recommendations.

The technical effect of generating charging recommendations from a plurality of battery charging parameters of an EV selected by a controller of the EV, is that the charging recommendations may take into account a wider variety of driver priorities than other recommendation systems, thereby increasing an adoption rate of the charging recommendations and lowering a carbon footprint of the EV and an overall population of EVs.

The disclosure also provides support for a system for an electric vehicle (EV), comprising: a controller storing executable instructions in non-transitory memory that, when executed, cause the controller to: prior to a future charge event of the EV, establish a secure anonymous connection with a charging recommendation system external to the EV, select a plurality of battery charging parameters to transmit to the charging recommendation system based on a classification and/or ranking of a relevancy of the battery charging parameters, transmit the selected battery charging parameters to the charging recommendation system via the secure anonymous connection, receive a charging recommendation for the future charge event of the EV from the charging recommendation system via the secure anonymous connection, the charging recommendation based at least partly on the selected battery charging parameters, and display the charging recommendation in a display of the EV and/or store the charging recommendation in a memory of the EV. In a first example of the system, the battery charging parameters include one or more charge event parameters collected and stored during a previous charge event, the charge event parameters including: charging time information, including starting times and ending times of the charge event, ignition-on/ignition-off times, a charging energy source type, a price of electricity used to charge the EV, a time-of-use (TOU) rate applied to the price of electricity, an amount of charge received during the charge event, and a state of charge (SOC) at a charge start time and at a charge end time. In a second example of the system, optionally including the first example, the battery charging parameters include one or more charging strategy parameters used to aid a driver in selecting a suitable charging station, the charging strategy parameters including: a current SOC of a battery of the EV, a type of the battery, a compatible charger type, location information of the EV, such as a current location, a previous location, and/or a destination of the EV, a current time of day or season, historical driver data, historical price information, for prices paid for electricity during recharging, historical route information, and cost share rewards and/or other incentives provided to drivers or owners of the EV. In a third example of the system, optionally including one or both of the first and second examples, the location information is retrieved from an onboard navigation system of the EV. In a fourth example of the system, optionally including one or more or each of the first through third examples, the historical driver data includes driver preferences for stopping locations and times based on past charge events. In a fifth example of the system, optionally including one or more or each of the first through fourth examples, the selected battery charging parameters are stored in a database of the charging recommendation system. In a sixth example of the system, optionally including one or more or each of the first through fifth examples, the charging recommendation for the future charge event includes one or more charging options, the charging options ranked based on a predicted preference of a driver and/or owner of the EV. In a seventh example of the system, optionally including one or more or each of the first through sixth examples, each option of the one or more charging options includes a candidate charging station, and a preferred time for recharging the EV. In a eighth example of the system, optionally including one or more or each of the first through seventh examples, the charging options are ranked based on an output of a machine learning (ML) model trained to predict the preference of the driver and/or owner of the EV based on the selected battery charging parameters. In a ninth example of the system, optionally including one or more or each of the first through eighth examples, the charging recommendation and/or charging options are generated based at least partly on an environmental cost value assigned to the future charge event. In a tenth example of the system, optionally including one or more or each of the first through ninth examples, the system further comprises: assessing an impact of charging recommendations based on a difference of a difference regression. In a eleventh example of the system, optionally including one or more or each of the first through tenth examples, the charging recommendation includes a comparison of environmental impacts of a charge event with other scenarios of environmental cost of a typical EV charge event.

The disclosure also provides support for an electric vehicle (EV) charging recommendation system, comprising: a processor storing executable instructions in non-transitory memory that, when executed, cause the processor to: establish a secure anonymous connection with a requesting EV, receive a set of battery charging parameters of the requesting EV via the secure anonymous connection, generate a charging recommendation for a future charge event of the EV based at least partly on the set of battery charging parameters, transmit the charging recommendation to the EV via the secure anonymous connection, and store the set of battery charging parameters in a database of the non-transitory memory. In a first example of the system, generating the charging recommendation for the future charge event of the EV further comprises: determining a set of candidate charging stations for the EV, based on one or more battery charging parameters, the one or more battery charging parameters including at least one of a location of the EV and a route of the EV, estimating cost and preference metrics for each candidate charging station, estimating sustainability metrics for each candidate charging station, based on assigning an environmental cost value to a future charge event of the EV at each of the candidate charging stations, ranking the future charge events based on the sustainability, cost, and preference metrics, selecting one or more charge options for the EV from the ranked future charge events, and including the one or more charge options in the charging recommendation transmitted to the EV. In a second example of the system, optionally including the first example, ranking the future charge events based on the sustainability, cost, and preference metrics further comprises using a machine learning (ML) model to rank the future charge events, the ML model taking as input the environmental cost values, the set of battery charging parameters, and the candidate charging stations, the ML model trained on historical charge event data of the EV. In a third example of the system, optionally including one or both of the first and second examples, assigning the environmental cost value to the future charge event of the EV further comprises: assigning an environmental impact rate/kWh to the future charge event based on one more charging scenarios, the one or more charging scenarios based on differing mixes of energy sources supplying energy for the future charge event, and adjusting the environmental impact rate/kWh based on one or more of: on-site infrastructure components, ongoing infrastructure servicing needs, vehicle and infrastructure battery degradation impacts and lifetime energy output, operational power needs, efficiency losses, local land use impacts, and distance deviation from an intended route of the EV.

The disclosure also provides support for a method, comprising: receiving, at a cloud-based charging recommendation system of an electric vehicle (EV) charging system, a set of battery charging parameters from an EV, via a secure anonymous connection, determining a set of candidate charging stations for the EV, based on the received battery charging parameters, estimating sustainability, cost, and preference metrics for each candidate charging station, ranking future charge events of the EV at the candidate charging stations based on the sustainability, cost, and preference metrics, selecting one or more charge options for the EV from the ranked future charge events, generating a charging recommendation including the one or more charge options, and transmitting the charging recommendation to the EV via the secure anonymous connection. In a first example of the method, estimating the sustainability metric further comprises assigning an environmental cost value to a future charge event of the EV at each of the candidate charging stations. In a second example of the method, optionally including the first example, ranking the future charge events based on the sustainability, cost, and preference metrics further comprises: using a machine learning (ML) model to output a score for each future charge event, the ML model taking as input the environmental cost values, the set of battery charging parameters, and the candidate charging stations, the ML model trained on historical charge event data of the EV, and ranking the future charge events based on the scores. In a third example of the method, optionally including one or both of the first and second examples, the preference metrics include at least one of: driver preferences for stopping locations and charging times, micro-mobility options for last-mile deliveries, and gamification of objectives like fitness goals, where additional walking or short bicycle rides between a charging station and a desirable location are incorporated into a charging strategy.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for an electric vehicle (EV), comprising:
a controller storing executable instructions in non-transitory memory that, when executed, cause the controller to:
prior to a future charge event of the EV, establish a secure anonymous connection with a charging recommendation system external to the EV;
select a plurality of battery charging parameters to transmit to the charging recommendation system based on a classification and/or ranking of a relevancy of the battery charging parameters;
transmit the selected battery charging parameters to the charging recommendation system via the secure anonymous connection;
receive a charging recommendation for the future charge event of the EV from the charging recommendation system via the secure anonymous connection, the charging recommendation based at least partly on the selected battery charging parameters; and
display the charging recommendation in a display of the EV and/or store the charging recommendation in a memory of the EV.

2. The system of claim 1, wherein the battery charging parameters include one or more charge event parameters collected and stored during a previous charge event, the charge event parameters including:
charging time information, including starting times and ending times of the charge event;
ignition-on/ignition-off times;
a charging energy source type;
a price of electricity used to charge the EV;
a time-of-use (TOU) rate applied to the price of electricity;
an amount of charge received during the charge event; and
a state of charge (SOC) at a charge start time and at a charge end time.

3. The system of claim 1, wherein the battery charging parameters include one or more charging strategy parameters used to aid a driver in selecting a suitable charging station, the charging strategy parameters including:
a current SOC of a battery of the EV;
a type of the battery;
a compatible charger type;
location information of the EV, such as a current location, a previous location, and/or a destination of the EV;
a current time of day or season;
historical driver data;
historical price information, for prices paid for electricity during recharging;
historical route information; and
cost share rewards and/or other incentives provided to drivers or owners of the EV.

4. The system of claim 3, wherein the location information is retrieved from an onboard navigation system of the EV.

5. The system of claim 3, wherein the historical driver data includes driver preferences for stopping locations and times based on past charge events.

6. The system of claim 1, wherein the selected battery charging parameters are stored in a database of the charging recommendation system.

7. The system of claim 1, wherein the charging recommendation for the future charge event includes one or more charging options, the charging options ranked based on a predicted preference of a driver and/or owner of the EV.

8. The system of claim 7, wherein each option of the one or more charging options includes a candidate charging station, and a preferred time for recharging the EV.

9. The system of claim 7, wherein the charging options are ranked based on an output of a machine learning (ML) model trained to predict the preference of the driver and/or owner of the EV based on the selected battery charging parameters.

10. The system of claim 1, wherein the charging recommendation and/or charging options are generated based at least partly on an environmental cost value assigned to the future charge event.

11. The system of claim 1, further comprising assessing an impact of charging recommendations based on a difference of a difference regression.

12. The system of claim 1, wherein the charging recommendation includes a comparison of environmental impacts of a charge event with other scenarios of environmental cost of a typical EV charge event.

13. An electric vehicle (EV) charging recommendation system, comprising:
a processor storing executable instructions in non-transitory memory that, when executed, cause the processor to:
establish a secure anonymous connection with a requesting EV;
receive a set of battery charging parameters of the requesting EV via the secure anonymous connection;
generate a charging recommendation for a future charge event of the EV based at least partly on the set of battery charging parameters;
transmit the charging recommendation to the EV via the secure anonymous connection; and
store the set of battery charging parameters in a database of the non-transitory memory.

14. The EV charging recommendation system of claim 13, wherein generating the charging recommendation for the future charge event of the EV further comprises:
determining a set of candidate charging stations for the EV, based on one or more battery charging parameters, the one or more battery charging parameters including at least one of a location of the EV and a route of the EV;
estimating cost and preference metrics for each candidate charging station;
estimating sustainability metrics for each candidate charging station, based on assigning an environmental cost value to a future charge event of the EV at each of the candidate charging stations;
ranking the future charge events based on the sustainability, cost, and preference metrics;
selecting one or more charge options for the EV from the ranked future charge events; and
including the one or more charge options in the charging recommendation transmitted to the EV.

15. The EV charging recommendation system of claim 14, wherein ranking the future charge events based on the sustainability, cost, and preference metrics further comprises using a machine learning (ML) model to rank the future charge events, the ML model taking as input the environmental cost values, the set of battery charging parameters, and the candidate charging stations, the ML model trained on historical charge event data of the EV.

16. The EV charging recommendation system of claim 14, wherein assigning the environmental cost value to the future charge event of the EV further comprises:
assigning an environmental impact rate/kWh to the future charge event based on one more charging scenarios, the one or more charging scenarios based on differing mixes of energy sources supplying energy for the future charge event; and
adjusting the environmental impact rate/kWh based on one or more of:
on-site infrastructure components;
ongoing infrastructure servicing needs;
vehicle and infrastructure battery degradation impacts and lifetime energy output;
operational power needs;
efficiency losses;
local land use impacts; and
distance deviation from an intended route of the EV.

17. A method, comprising:
receiving, at a cloud-based charging recommendation system of an electric vehicle (EV) charging system, a set of battery charging parameters from an EV, via a secure anonymous connection;
determining a set of candidate charging stations for the EV, based on the received battery charging parameters;
estimating sustainability, cost, and preference metrics for each candidate charging station;
ranking future charge events of the EV at the candidate charging stations based on the sustainability, cost, and preference metrics;
selecting one or more charge options for the EV from the ranked future charge events;
generating a charging recommendation including the one or more charge options; and
transmitting the charging recommendation to the EV via the secure anonymous connection.

18. The method of claim 17, wherein estimating the sustainability metric further comprises assigning an environmental cost value to a future charge event of the EV at each of the candidate charging stations.

19. The method of claim 18, wherein ranking the future charge events based on the sustainability, cost, and preference metrics further comprises:
using a machine learning (ML) model to output a score for each future charge event, the ML model taking as input the environmental cost values, the set of battery charging parameters, and the candidate charging stations, the ML model trained on historical charge event data of the EV; and
ranking the future charge events based on the scores.

20. The method of claim 17, where the preference metrics include at least one of:
driver preferences for stopping locations and charging times;
micro-mobility options for last-mile deliveries; and
gamification of objectives like fitness goals, where additional walking or short bicycle rides between a charging station and a desirable location are incorporated into a charging strategy.
